(19) United States
(12) Patent Application Publication
(10) Pub. No.: US 2014/0065580 A1
(43) Pub. Date: Mar. 6, 2014

(54) Method and System of Emulating a Patient Programmer

(71) Applicant: Greatbatch Ltd., Clarence, NY (US)

(72) Inventors: Norbert Kaula, Arvada, CO (US); Yohannes Iyassu, Denver, CO (US)

(21) Appl. No.: 14/010,913

(22) Filed: Aug. 27, 2013

Related U.S. Application Data
(60) Provisional application No. 61/695,421, filed on Aug. 31, 2012.

(51) Int. Cl. G09B 19/00

(52) U.S. Cl. CPC G09B 19/0053
USPC 434/118

(57) ABSTRACT

The present disclosure involves a method of emulating a patient programmer. A first language is associated with a virtual representation of the patient programmer. The first language corresponds to a language understood by a healthcare professional. A second language is associated with the virtual representation of the patient programmer. The second language corresponds to a language understood by a patient user of the patient programmer. The virtual representation of the patient programmer is displayed in the first language and in the second language simultaneously.

### PRIORITY DATA

The present application is a utility application of provisional U.S. Patent Application No. 61/695,421, filed on Aug. 31, 2012, entitled “Method and System of Emulating a Patient Programmer,” the disclosures of which is hereby incorporated by reference in its entirety.

### BACKGROUND

As medical device technologies continue to evolve, active implanted medical devices have gained increasing popularity in the medical field. For example, one type of implanted medical device includes neurostimulator devices, which are battery-powered or battery-less devices designed to deliver electrical stimulation to a patient. Through proper electrical stimulation, the neurostimulator devices can provide pain relief for patients or restore bodily functions.

Implanted medical devices (for example, a neurostimulator) can be controlled using an electronic programming device such as a clinician programmer or a patient programmer. These programmers can be used by medical personnel or the patient to define the particular electrical stimulation therapy to be delivered to a target area of the patient's body, to alter one or more parameters of the electrical stimulation therapy, or otherwise to conduct communications with a patient.

Despite many advances made in the field of neurostimulation, one drawback is that the existing clinician programmers have not been able to provide a sufficiently versatile emulation of the patient programmer. The lack of versatile patient programmer emulation leads to problems, for example problems related to remote trouble shooting, training, research development, or in other contexts where the external hardware or implants are not available. These problems may lead to increased costs and longer troubleshooting or training sessions.

Therefore, although existing clinician programmers have been generally adequate for their intended purposes, they have not been entirely satisfactory in every aspect.

### SUMMARY

One aspect of the present disclosure involves an electronic apparatus for emulating a patient programmer. The electronic device includes: a touchscreen display configured to receive a tactile input from a user and display a visual output; a memory storage component configured to store programming code; and a computer processor configured to execute the programming code to perform the following tasks: associating a first language with a virtual representation of the patient programmer, the first language corresponding to a language understood by a healthcare professional; associating a second language with the virtual representation of the patient programmer, the second language corresponding to a language understood by a patient user of the patient programmer; and displaying the virtual representation of the patient programmer in the first language and in the second language simultaneously.

Another aspect of the present disclosure involves a medical system. The medical system includes: a patient programmer configured to adjust a stimulation therapy that is delivered to a patient through an implanted pulse generator; and an electronic device configured to provide an emulation of the patient programmer, wherein the electronic device includes a non-transitory, tangible machine-readable storage medium storing executable instructions that when executed electronically by one or more processors, perform the following steps: associating a first language with a virtual representation of the patient programmer, the first language corresponding to a language understood by a healthcare professional; associating a second language with the virtual representation of the patient programmer, the second language corresponding to a language understood by a patient user of the patient programmer; and displaying the virtual representation of the patient programmer in the first language and in the second language simultaneously.

Yet another aspect of the present disclosure involves a method of emulating a patient programmer. The method includes: associating a first language with a virtual representation of the patient programmer, the first language corresponding to a language understood by a healthcare professional; associating a second language with the virtual representation of the patient programmer, the second language corresponding to a language understood by a patient user of the patient programmer; and displaying the virtual representation of the patient programmer in the first language and in the second language simultaneously

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. In the figures, elements having the same designation have the same or similar functions.

FIG. 1 is a simplified block diagram of an example medical environment in which evaluations of a patient may be conducted according to various aspects of the present disclosure.

FIGS. 2-8 are different screens of a user interface for emulating a patient programmer according to various aspects of the present disclosure.

FIGS. 9-10 are simplified block diagrams illustrating example environments in which a patient programmer is emulated according to an embodiment of the present disclosure.

FIGS. 11-13 are simplified flowcharts illustrating a method of emulating a patient programmer according to various aspects of the present disclosure.

FIG. 14 is a simplified block diagram of an electronic programmer according to various aspects of the present disclosure.

FIG. 15 is a simplified block diagram of an implantable medical device according to various aspects of the present disclosure.

FIG. 16 is a simplified block diagram of a medical system/infrastructure according to various aspects of the present disclosure.

FIGS. 17A and 17B are side and posterior views of a human spine, respectively.

FIG. 18 is a simplified block diagram of an embodiment of a clinician programmer according to various aspects of the present disclosure.

FIGS. 19A-19B are simplified block diagrams of two example systems involving a clinician programmer, one or more patient programmers, and a pulse generator according to various aspects of the present disclosure.

FIG. 20 is a simplified flowchart of a method of using a clinician programmer to remote control a patient programmer according to various aspects of the present disclosure.

### DETAILED DESCRIPTION

It is to be understood that the following disclosure provides many different embodiments, or examples, for implementing different features of the invention. Specific examples of components and arrangements are described below to simplify the present disclosure. These are, of course, merely examples and are not intended to be limiting. Various features may be arbitrarily drawn in different scales for simplicity and clarity.

The use of active implanted medical devices has become increasingly prevalent over time. Some of these implanted medical devices include neurostimulator devices that are capable of providing pain relief by delivering electrical stimulation to a patient. In that regards, electronic programmers have been used to configure or program these neurostimulators (or other types of suitable active implanted medical devices) so that they can be operated in a certain manner. These electronic programmers include clinician programmers and patient programmers, each of which may be a handheld device. For example, a clinician programmer allows a medical professional (e.g., a doctor or a nurse) to define the particular electrical stimulation therapy to be delivered to a target area of the patient's body, while a patient programmer allows a patient to alter one or more parameters of the electrical stimulation therapy.

In recent years, these electronic programmers have achieved significant improvements, for example, improvements in size, power consumption, lifetime, and ease of use. Despite these advances, the capabilities of electronic programmers have not been fully exploited, for example, in terms of providing a versatile emulation of the patient programmer. In general, emulation refers to the use of computers to imitate or represent another device and the capabilities of that device. Emulation of patient programmers allows the healthcare professional and patient greater flexibility with respect to communication, particularly in two situations: when the healthcare professional and the patient speak different languages, and when the healthcare professional needs to help troubleshoot problems remotely. Healthcare professionals who speak the same language or dialect as a patient are not always available. If a patient who requires stimulation therapy does not speak the same language or dialect as the healthcare professional who treats the patient, a translator may be needed, and the patient programmer can display one language while the clinician programmer can display another. Therefore, if the training on how to use the patient programmer is done in the patient's language, the healthcare professional has to explain every aspect of the patient programmer from memory. On the other hand, if the training is done in the healthcare professional's language, the patient can become confused and has to remember everything the healthcare professional said without written aids. Another problem with the use of programmers is remote troubleshooting. In more detail, if a patient has difficulty using a patient programmer, the patient either has to visit the healthcare professional or try to describe the problem to the healthcare professional remotely over the phone/email/etc. If a patient's problem stems from the lack of understanding of the patient programmer, descriptions of the problem and the way the patient used the patient programmer that led to the problem can be inadequate.

To address the issues discussed above, the present disclosure offers a method and system of providing a versatile emulation of a patient programmer on an electronic device, which may be a clinician programmer, a tablet computer, or a computer, as discussed below in more detail.

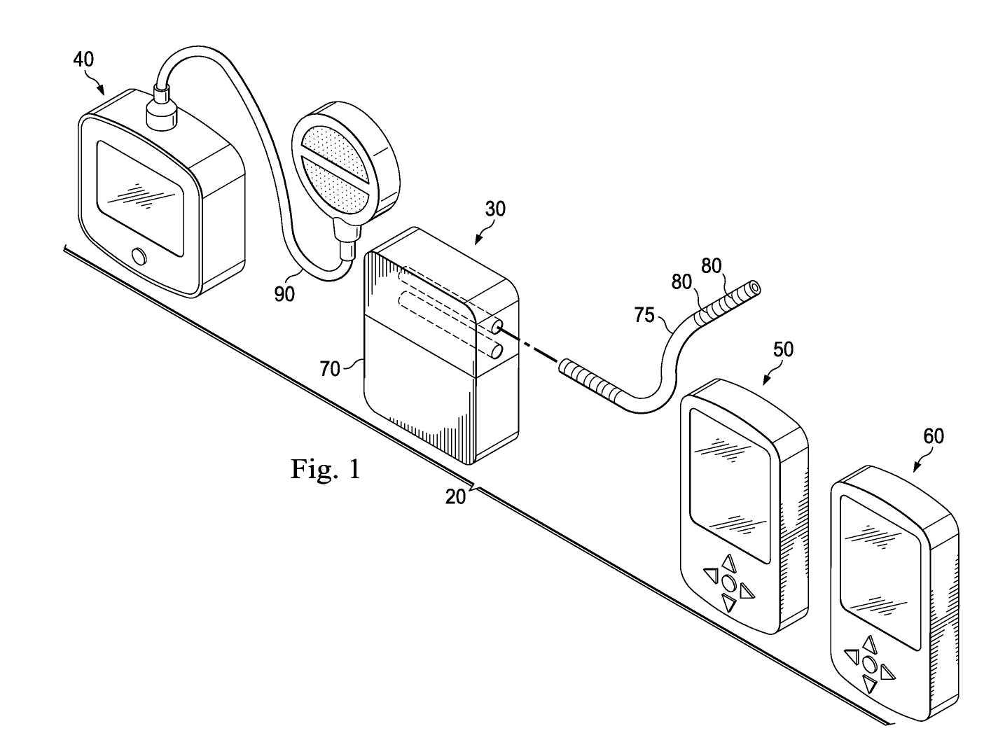

FIG. 1 is a simplified block diagram of a medical device system 20 is illustrated to provide an example context of the various aspects of the present disclosure. The medical system 20 includes an implantable medical device 30, an external charger 40, a patient programmer 50, and a clinician programmer 60. The implantable medical device 30 can be implanted in a patient's body tissue. In the illustrated embodiment, the implantable medical device 30 includes an implanted pulse generator (IPG) 70 that is coupled to one end of an implanted lead 75. The other end of the implanted lead 75 includes multiple electrode surfaces 80 through which electrical current is applied to a desired part of a body tissue of a patient. The implanted lead 75 incorporates electrical conductors to provide a path for that current to travel to the body tissue from the IPG 70. Although only one implanted lead 75 is shown in FIG. 1, it is understood that a plurality of implanted leads may be attached to the IPG 70.

Although an IPG is used here as an example, it is understood that the various aspects of the present disclosure apply to an external pulse generator (EPG) as well. An EPG is intended to be worn externally to the patient's body. The EPG connects to one end (referred to as a connection end) of one or more percutaneous, or skin-penetrating, leads. The other end (referred to as a stimulating end) of the percutaneous lead is implanted within the body and incorporates multiple electrode surfaces analogous in function and use to those of an implanted lead.

The external charger 40 of the medical device system 20 provides electrical power to the IPG 70. The electrical power may be delivered through a charging coil 90. In some embodiments, the charging coil can also be an internal component of the external charger 40. The IPG 70 may also incorporate power-storage components such as a battery or capacitor so that it may be powered independently of the external charger 40 for a period of time, for example from a day to a month, depending on the power requirements of the therapeutic electrical stimulation delivered by the IPG.

The patient programmer 50 and the clinician programmer 60 may be portable handheld devices that can be used to configure the IPG 70 so that the IPG 70 can operate in a certain way. The patient programmer 50 is used by the patient in whom the IPG 70 is implanted. The patient may adjust the parameters of the stimulation, such as by selecting a program, changing its amplitude, frequency, and other parameters, and by turning stimulation on and off. The clinician programmer 60 is used by a medical personnel to configure the other system components and to adjust stimulation parameters that the patient is not permitted to control, such as by setting up stimulation programs among which the patient may choose, selecting the active set of electrode surfaces in a given program, and by setting upper and lower limits for the patient's adjustments of amplitude, frequency, and other parameters.

In the embodiments discussed below, the clinician programmer 60 is used as an example of the electronic programmer. However, it is understood that the electronic programmer may also be the patient programmer 50 or other touch screen programming devices (such as smart-phones or tablet computers) in other embodiments.

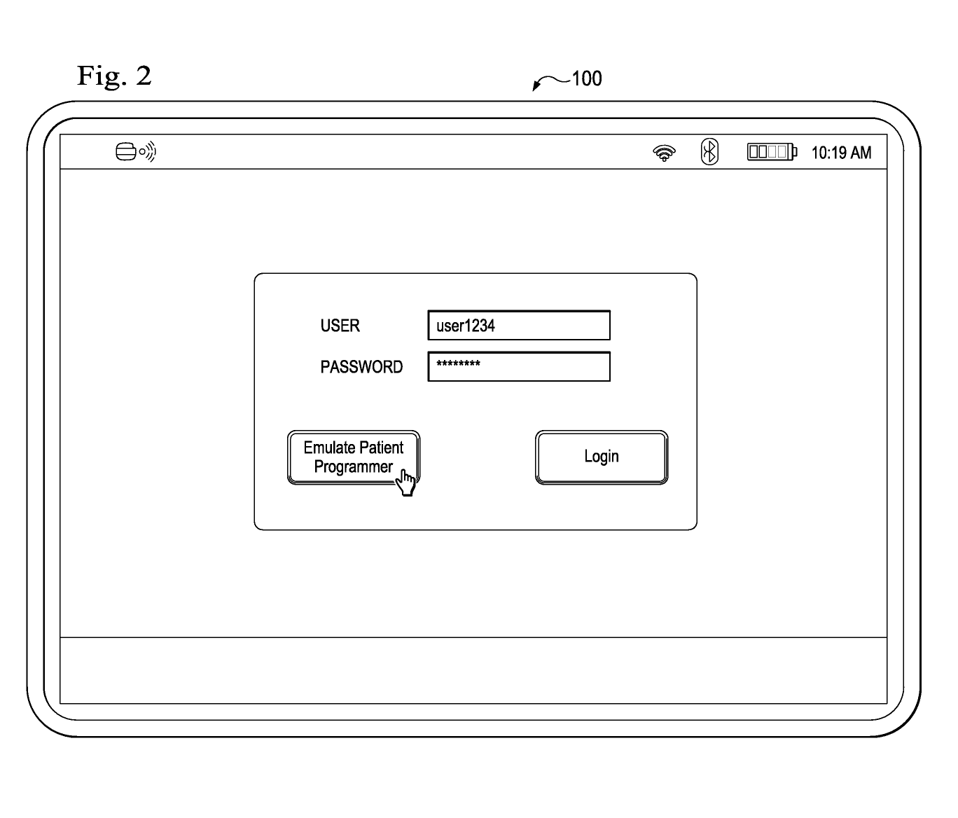

FIGS. 2-8 illustrate an example user interface 100 of an embodiment of the clinician programmer 60. The interface 100 is displayed on a touch-sensitive screen of the clinician programmer and allows for interactive input/output for a target user, which may be a healthcare professional, for example a doctor or a nurse. The user and the healthcare professional are interchangeably referred in the following paragraphs, but it is understood that they need not necessarily be the same entity.

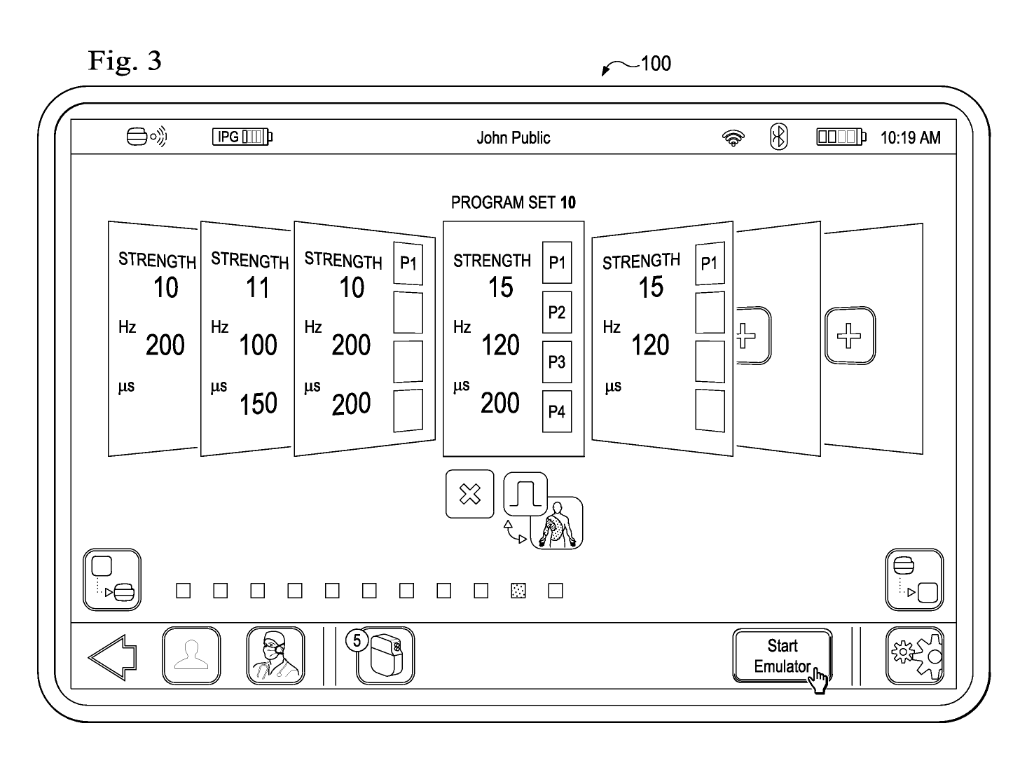

Referring to FIG. 2, the user interface 100 allows the user to start the patient programmer emulator application by choosing the “Emulate Patient Programmer” option at a login screen of the clinician programmer application. The user may have full access to the data on the clinician programmer once the patient programmer emulator application launches. In an embodiment, the patient programmer emulator application may be started from within the clinician programmer application, such as illustrated in FIG. 3. As shown in FIG. 3, the user may start the patient programmer emulator application from a screen showing the different stimulation pulses that have been programmed. Of course, the patient programmer emulator application may be launched from another screen within the clinician programmer application as well.

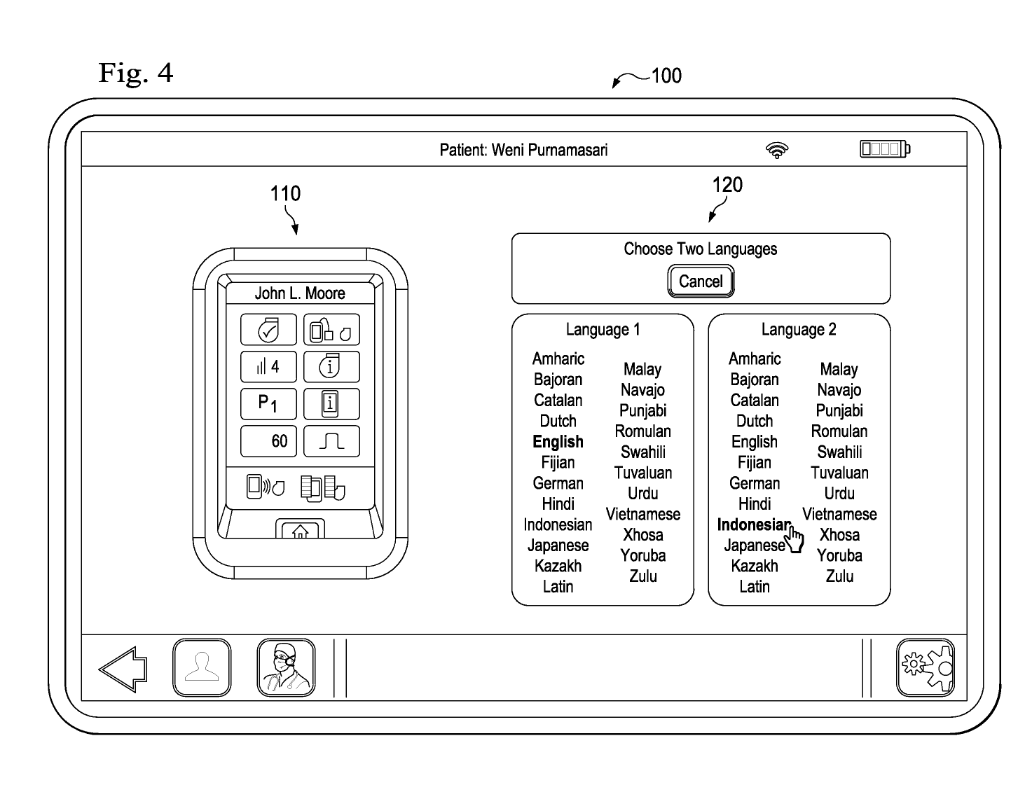

Referring now to FIG. 4, the user interface 100 displays a screenshot of the patient programmer emulator application. The patient programmer emulator application includes a virtual representation 110 of the patient programmer. In the embodiment shown, the virtual representation of a patient programmer charger (PPC) is shown as an example of an emulated patient programmer. In other embodiments, a virtual representation of a pocket programmer (PoP) may be shown as an example of an emulated patient programmer. The patient programmer charger (PPC) and the pocket programmer (PoP) are discussed in greater detail in U.S. patent application Ser. No. 13/170,558, filed on Jun. 28, 2011, and entitled “Key Fob Controller for an Implantable Neurostimulator”, and U.S. patent application Ser. No. 13/170,775, filed on Jun. 28, 2011, and entitled “Dual Patient Controllers”, the contents of which are hereby incorporated by reference in their entirety. The patient programmer emulator application is not limited to just the PPC or the PoP but is capable of emulating other types of patient programmers as well.

The virtual representation 110 represents the actual patient programmer belonging to a target patient—patient “Weni Purnamasari” in this case. Of course, as the patient is changed, the virtual representation 110 may be updated to reflect the actual patient programmer owned by the currently-selected patient as well. It is also understood that the patient programmer emulator application has access to all the information that resides on the actual patient programmer that is being emulated. Such information may include, but is not limited to, the biographical information of the patient such as name, age, gender, body type, address, or medical information such as the details of the stimulation therapy for the patient, which may include stimulation parameters such as current amplitude, frequency, pulse width, and electrode configuration. In some embodiments, the patient programmer emulator application retrieves the patient information from a communications link established with the actual patient programmer. In other embodiments, the patient programmer emulator application can download the patient information from a database, which may be a database stored in the clinician programmer locally, or a remote database residing on a remote electronic server. It is also understood that the interface shown herein may be used to actually control the patient programmer (as opposed to merely emulating the patient programmer) in some embodiments.

With the retrieved patient information, the patient programmer emulator application of the present disclosure can offer a customized emulation of the target patient programmer, since the retrieved patient information allows the healthcare professional using the patient programmer emulator application to “see” what the patient actually sees when using the patient programmer. It is understood, however, that the patient programmer emulator application does not necessarily allow the healthcare professional to directly control the actual patient programmer. In many embodiments, the patient programmer emulator application merely allows the user to simulate the interactive experience of using the patient programmer, but any virtual operation performed using the virtual representation 110 of the patient programmer has no effect on the actual patient programmer. This may be implemented for safety reasons, since it may be undesirable to allow the patient's treatment parameters to be changed remotely, especially if there is a risk of the patient being “stuck” in an uncomfortable stimulation mode. In some embodiments, however, the patient programmer emulator application may be configured to control the actual patient programmer. This may be done when the healthcare professional has passed certain requirements that demonstrate his/her proficiency in programming the patient programmer, and the patient has given the healthcare professional authorization to perform programming on the patient programmer via the emulation program discussed herein.

The patient programmer emulator application also displays a menu 120 that prompts the user to choose two languages 1 and 2. One of the languages is a language understood by the healthcare professional (i.e., the user), and the other language is a language understood by the patient owner (also referred to as the patient user) of the patient programmer. In the embodiment shown, the user chooses English as the language understood by the user and Indonesian as the language understood by the patient.

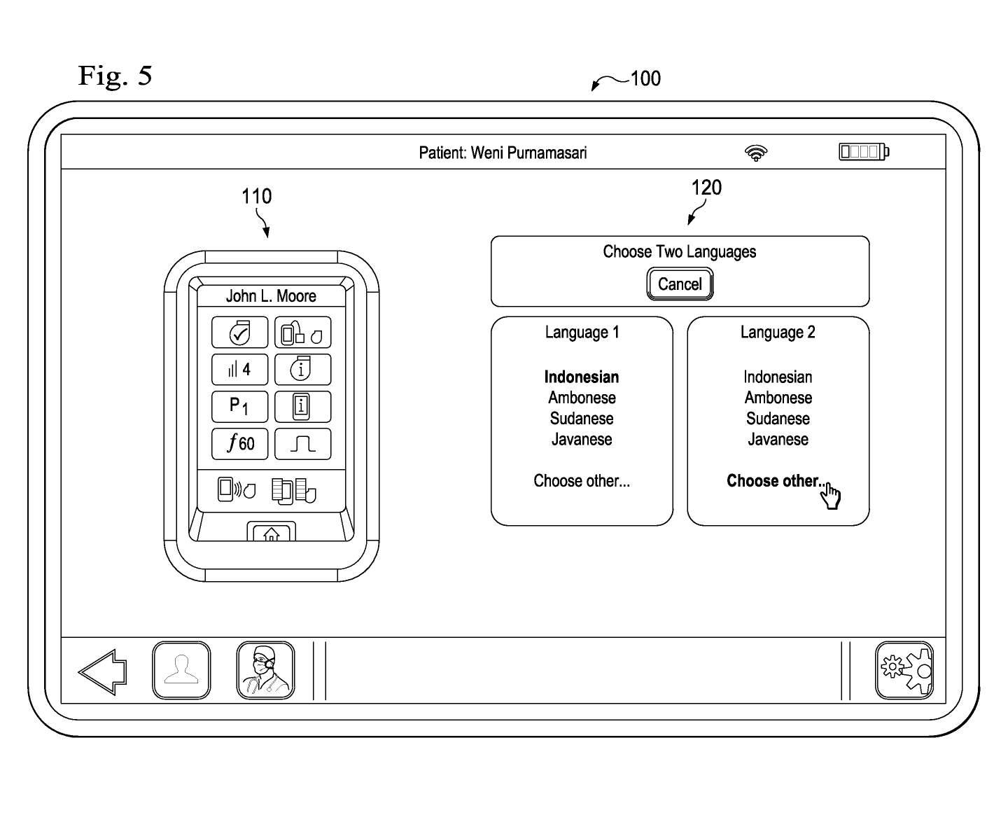

Though the embodiment shown in FIG. 4 allows the user to select the languages 1 and 2 for the user and the patient from a list of available languages, these languages 1 and 2 may be suggested in alternative embodiments. For example, referring to FIG. 5, the patient programmer emulator application may recommend languages 1 and 2 for the user and the patient based on their respective locations. For example, if the user is in country A, which may be indicated by the patient programmer emulator application detecting that the clinician programmer is in country A, then the patient programmer emulator application may automatically recommend a list of languages spoken in country A as the language 1. Similarly, through electronic communication with the patient programmer, the patient programmer emulator application may detect that the patient programmer is located in country B. The patient programmer emulator application may therefore recommend a list of languages spoken in country B as the language 2.

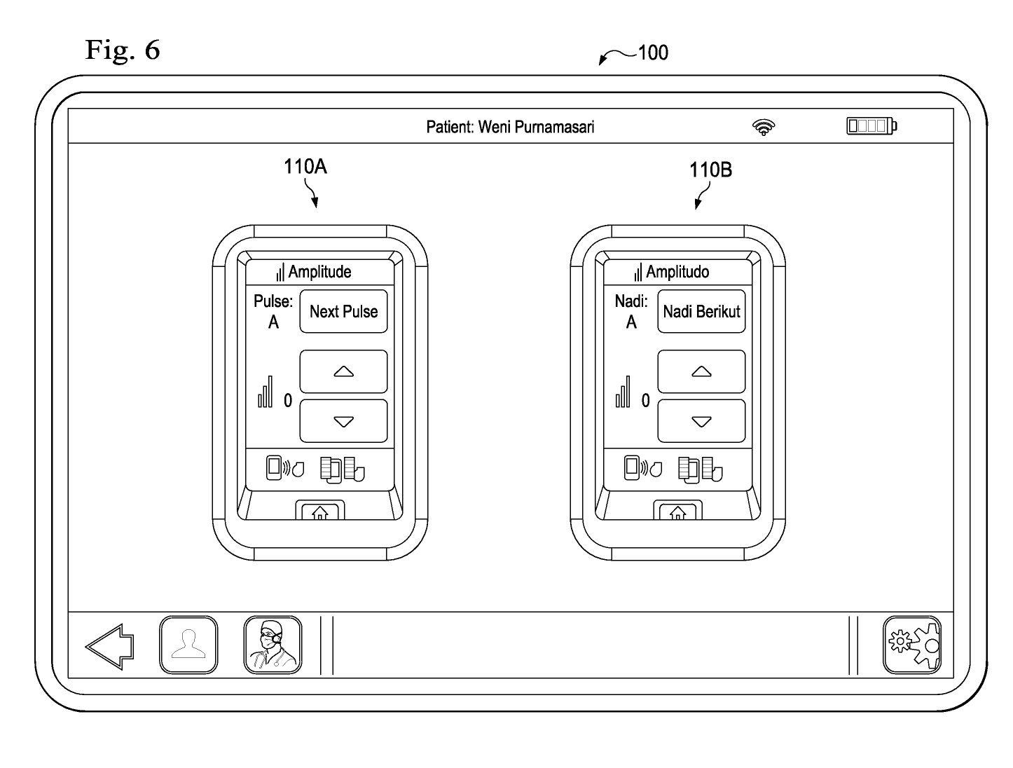

Referring now to FIG. 6, once the languages are chosen, the patient programmer emulator application can display a split screen with a virtual representation 110A of the patient programmer along with another virtual representation 110B of the patient programmer. Language 1 is used for the display of the virtual representation 110A of the patient programmer, and language 2 is used for the display of the virtual representation 110B of the patient programmer. In the embodiment shown in FIG. 6, the virtual representations 110A and 110B are simultaneously displayed side by side and mirror each other.

In some embodiments, assuming that the patient programmer emulator application has established a communications channel with the actual patient programmer, if the user performs a virtual operation using one of the virtual representations 110A/110B, the display of the other virtual representation 110B/110A will be updated automatically as well. As non-limiting examples, the virtual operation may include selecting a menu item on the virtual representation of the patient programmer, or adjusting a stimulation parameter on the virtual representation of the patient programmer, or merely pressing a button on the virtual representation of the patient programmer. In some embodiments, the virtual operation performed via the patient programmer emulator application may update the display on the actual patient programmer being emulated, though the stimulation therapy on the actual patient programmer may or may not be changed by the virtual operation. Conversely, in some embodiments, if the patient user performs an actual operation using the actual patient programmer, signals are therefore sent over the communications channel between the patient programmer and the clinician programmer. Accordingly, the patient programmer emulator application updates the display of the virtual representations 110A/100B to reflect the change in the display of the actual patient programmer too.

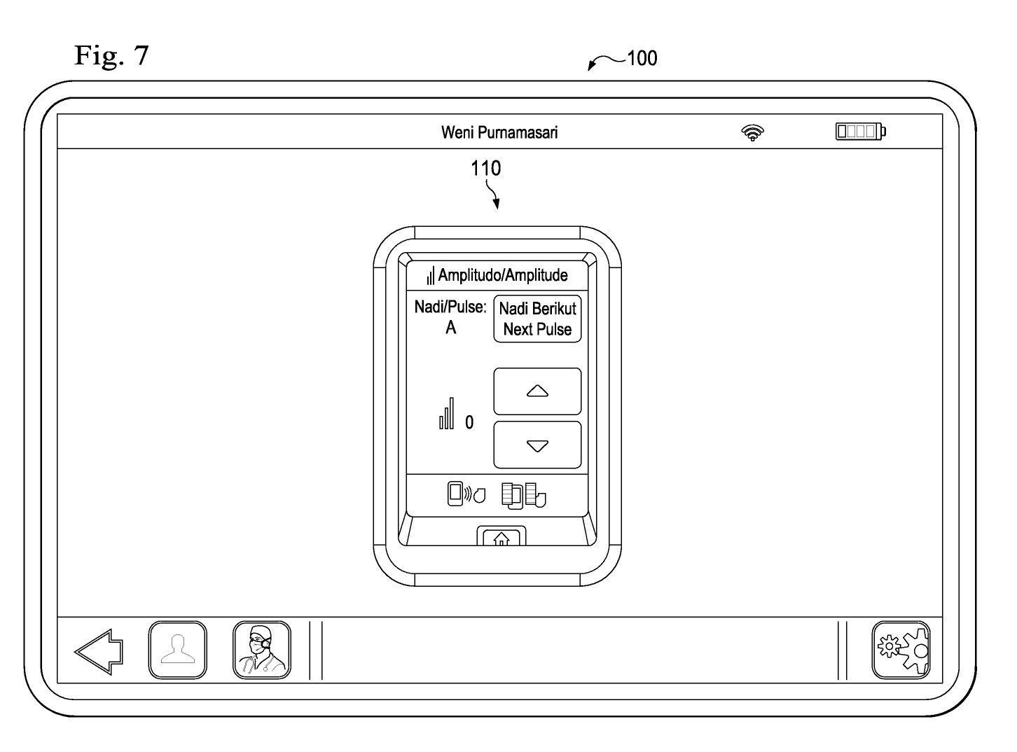

FIG. 7 illustrates an alternative display of the different languages on the virtual representation of the patient programmer. Referring to FIG. 7, the patient programmer emulator only displays a single virtual representation 110 of the patient programmer. However, the menu items and stimulation parameters on the virtual representation 110 of the patient programmer are displayed both in the two languages 1 and 2, for example in a side by side manner. In some embodiments, the two languages are displayed with different colors, fonts, or font sizes in order to help the user visually differentiate them.

Though the embodiments above illustrate the patient programmer emulator application being displayed on a screen of a clinician programmer, it is understood that the patient programmer emulator application may be displayed on a screen of a tablet computer, a monitor, or a computer as well. In some embodiments, the clinician programmer itself may be emulated along with the patient programmer.

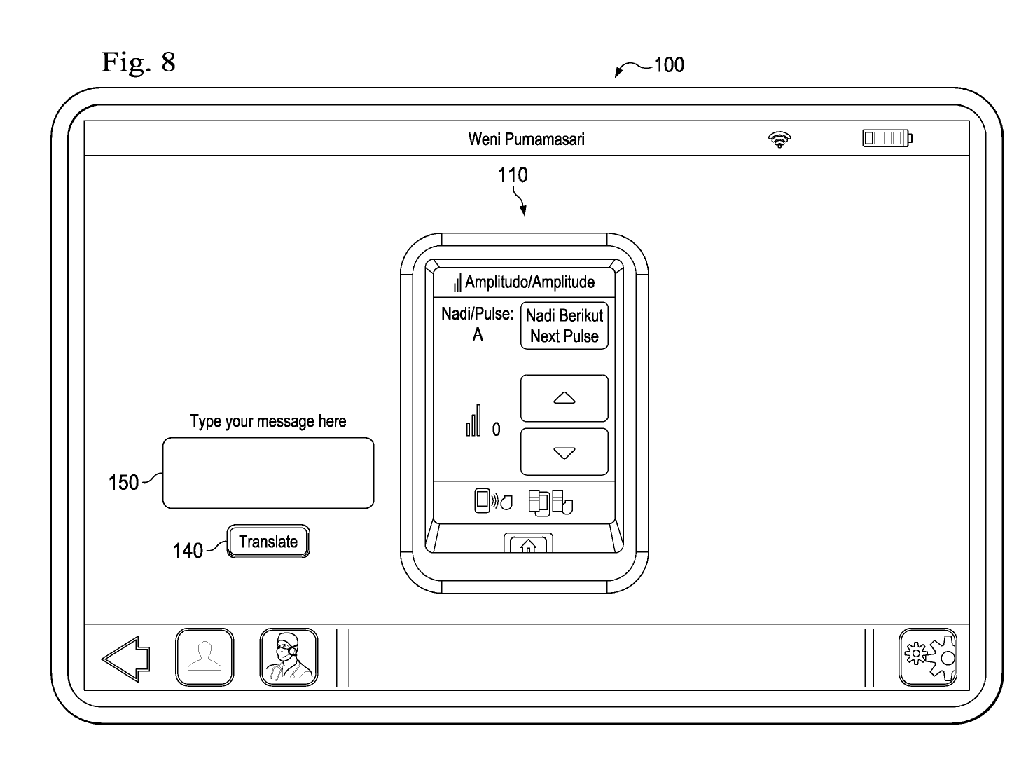

It is also understood that the patient programmer emulator application may offer translational capabilities. Translations may be made from language 1 to language 2 (i.e., the two languages associated with the healthcare professional and the patient, respectively) or vice versa in an audible manner, or in a textual manner, or both. For example, referring to FIG. 8, the user may click on any of the buttons or menu items shown in the virtual representation 110 and translate it audibly into the other language, for example via a translate button 140 shown in the emulation application. In addition, the emulation application may also allow the user to input a message, for example through a message input window 150. The user may type or speak the message into the message input window 150. Thereafter, the user may click on the translate button 140 to generate an automatic translation of the message. The translated message may be sent to the actual patient programmer via the communications link established therebetween, in which case the patient may see the translated message being displayed on his/her patient programmer. The translated message may also be audibly announced, in which case the patient may hear the translated message, for example through a telephone call. By allowing messages to be generated and translated, the patient programmer emulation application of the present disclosure further improves the communication between the healthcare professional and the patient, and may even obviate the need of a translator.

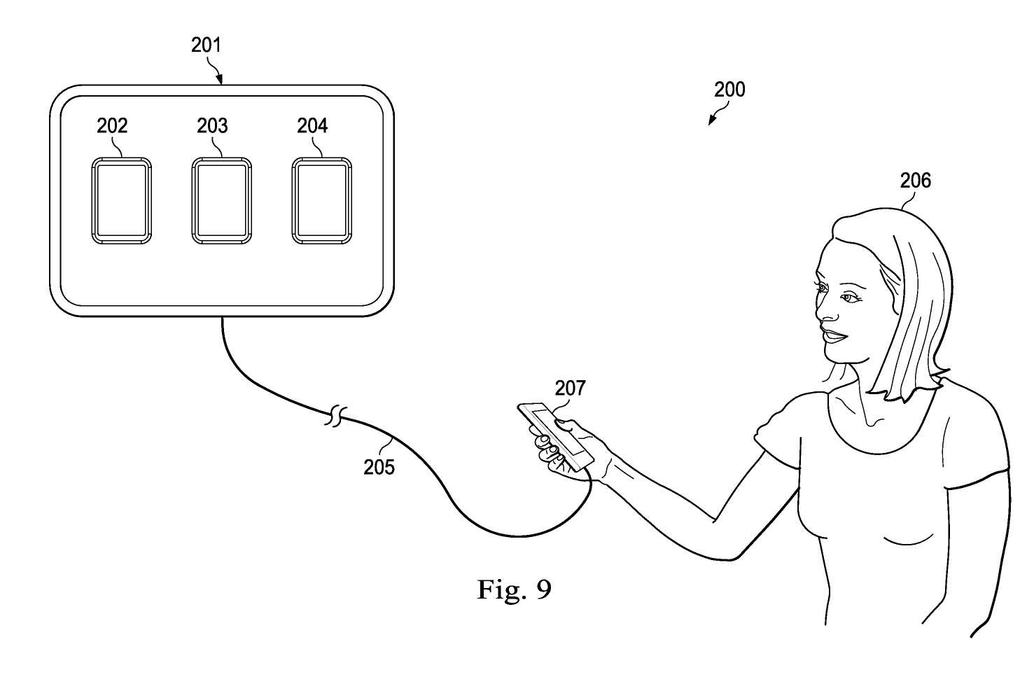

FIG. 9 illustrates a simplified block diagram of an example context or environment 200 in which the patient programmer may be emulated. Referring to FIG. 9, an external monitor 201 is provided. The external monitor 201 may be provided in accordance with U.S. patent application Ser. No. 13/600,875, filed on Aug. 31, 2012, entitled “Clinician Programming System and Method,” attorney docket No. 46901.11/QiG068, the disclosure of which is hereby incorporated by reference in its entirety. A plurality of emulated views 202-204 of a patient programmer may be displayed via the external monitor 201. Each of the emulated views 202-204 of the patient programmer may be provided in a different language. Meanwhile, the external monitor 201 may be communicatively coupled to a clinician programmer 207 through a connection 205. The connection 205 may be a wired connection or a wireless connection. The clinician programmer 207 may be an embodiment of the clinician programmer 60 discussed above. Another emulated view of the patient programmer is displayed on the clinician programmer 207. The emulated view of the patient programmer displayed on the clinician programmer 207 may be in yet another language. A user 206, for example a healthcare professional, may train the patient on how to use the patient programmer or help the patient troubleshoot problems with the patient programmer in the context 200.

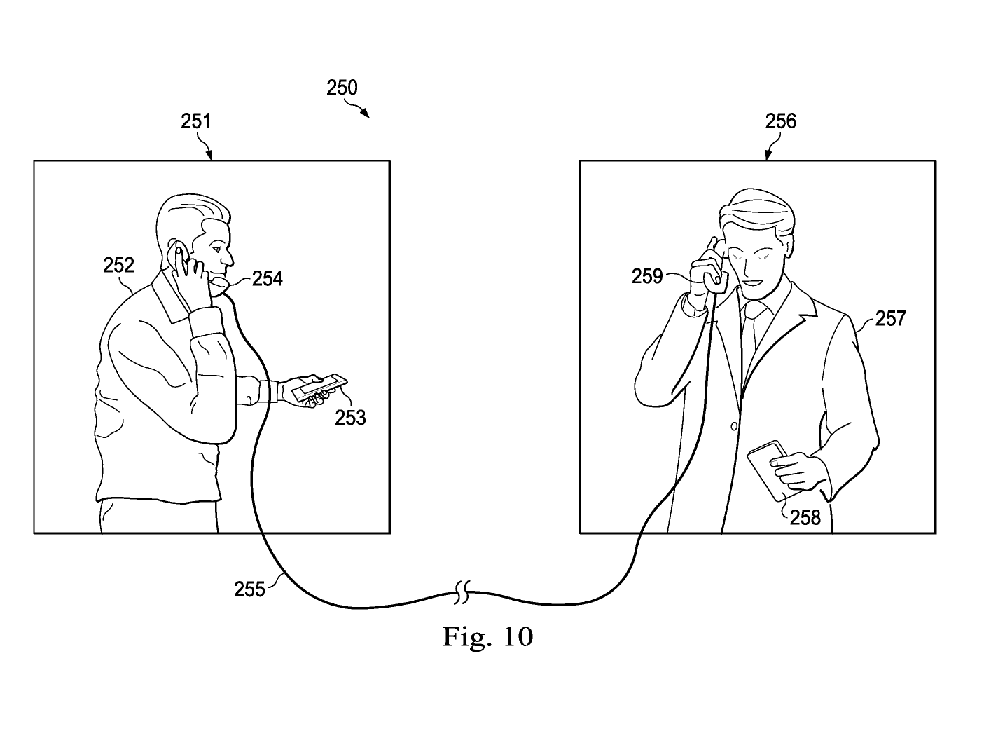

FIG. 10 illustrates a simplified block diagram of an example context or environment 250 in which the patient programmer may be emulated. Referring to FIG. 10, a patient 252 is located in a patient location 251. The patient 252 is the user of a patient programmer 253, which may be a patient programmer charger (PPC) or a pocket programmer (PoP). Meanwhile, a healthcare professional 257 is located in a healthcare institution 256, which is remotely located from the patient location 251. The healthcare professional 257 is the user of a clinician programmer 258. The clinician programmer 258 may be an embodiment of the clinician programmer 60 discussed above. The patient 252 also has a communications device 254, which may be a telephone or a computer. The healthcare professional 257 also has a communications device 259, which may be a telephone or a computer. The patient 252 and the healthcare professional 257 are in communication via their respective communications devices 254 and 259, which are communicatively coupled via a communications link 255 (a telephone line in the example illustrated herein). The patient 252 can telephone (or email) the healthcare professional 257 to ask about problems with the patient programmer 253. The healthcare professional 257 starts the patient programmer emulator on the clinician programmer 258 in response to the user's phone call (or email). Via the patient programmer emulator, the healthcare professional 257 can duplicate the patient's patient programmer and walk the patient through in a step-by-step process to help diagnose and resolve the problem for the patient.

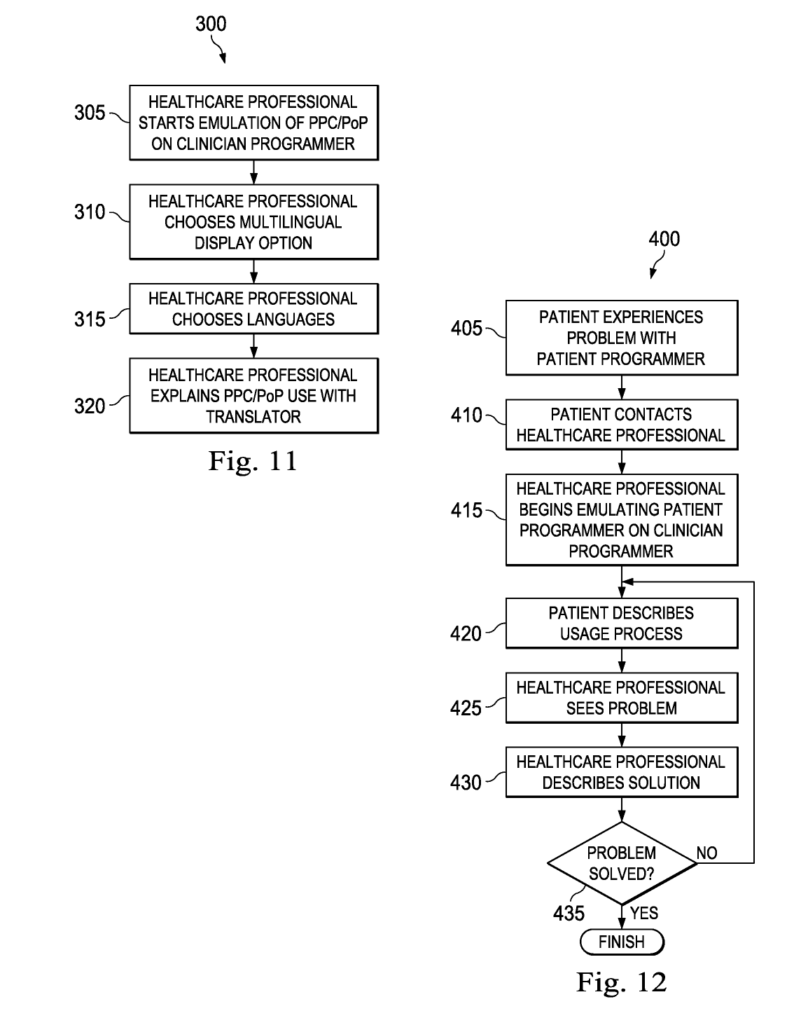

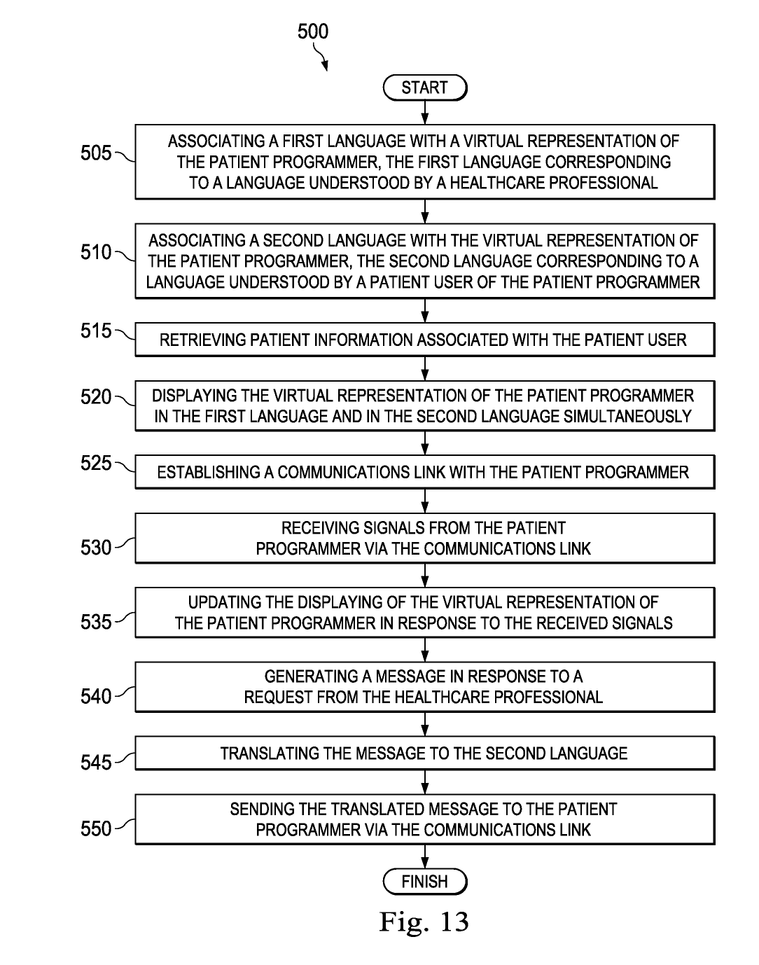

FIG. 11 is a simplified flowchart of a method 300 of performing a multilingual training according to the various aspects of the present disclosure. The method 300 includes a step 305, in which a healthcare professional starts the patient programmer emulation application on a clinician programmer. The patient programmer may be a patient programmer charger (PPC) or a pocket programmer (PoP). In other embodiments, the patient programmer emulation application may be started on a tablet computer or a computer.

The method 300 includes a step 310, in which the healthcare professional chooses a multilingual display option within the patient programmer emulation application. One of the languages may be associated with the language of the healthcare professional, and the other of the languages may be associated with the language of the patient user of the actual patient programmer being emulated. In some embodiments, the languages may be recommended to the healthcare professional based on the respective locations of the healthcare professional and the patient user.

The method 300 includes a step 315, in which the healthcare professional chooses the languages. The method 300 includes a step 320, in which the healthcare professional explains the use of the patient programmer (PPC or PoP), which may be facilitated with the use of a translator in some embodiments. In other embodiments, the patient programmer emulation application includes automatic translation capabilities, so that the healthcare professional may automatically translate a message or a command (which may be verbal or written) from the language of the healthcare professional to the language spoken by the patient user.

It is understood that the method 300 may include additional steps that may be performed before, during, or after the steps 305-320, but these additional steps are not illustrated herein for reasons of simplicity.

FIG. 12 is a simplified flowchart of a method 400 of performing remote trouble shooting according to the various aspects of the present disclosure. The method 400 includes a step 405, in which the patient experiences problem(s) with the patient programmer, which may include a PPC or a PoP. The method 400 includes a step 410, in which the patient contacts the healthcare professional to resolve the problem. The method 400 includes a step 415, in which the healthcare professional begins emulating the patient programmer on the clinician programmer. The method 400 includes a step 420, in which the patient describes the usage process to the healthcare professional. The method 400 includes a step 425, in which the healthcare professional diagnoses the problem via the patient programmer emulation application on the clinician programmer. The method 400 includes a step 430, in which the healthcare professional describes the solution to the patient. The method 400 includes a decision step 435 to determine whether the problem is solved. If the answer is no, then the method 400 loops back to the step 420 where the patient describes the usage process again. If the answer from the decision step 435 is yes, then the method 400 concludes.

It is understood that the method 400 may include additional steps that may be performed before, during, or after the steps 405-435, but these additional steps are not illustrated herein for reasons of simplicity.

FIG. 12 is a simplified flowchart of a method 500 of emulating a patient programmer according to the various aspects of the present disclosure. The method 500 includes a step 505 of associating a first language with a virtual representation of the patient programmer. The first language corresponds to a language understood by a healthcare professional.

The method 500 includes a step 510 of associating a second language with the virtual representation of the patient programmer. The second language corresponds to a language understood by a patient user of the patient programmer.

The method 500 includes a step 515 of retrieving patient information associated with the patient user. In various embodiments, the patient information may include information regarding an electrical stimulation therapy delivered to the patient user by a medical device (e.g., an implantable pulse generator (IPG)) implanted in the patient user. In some embodiments, the electrical stimulation therapy may include the following parameters: current amplitude, frequency, pulse width, and electrode configuration on the IPG.

The method 500 includes a step 520 of displaying the virtual representation of the patient programmer in the first language and in the second language simultaneously. At least a subset of the retrieved patient information is displayed in the virtual representation of the patient programmer. In some embodiments, the step 520 of displaying the virtual representation includes displaying the first and second virtual representations of the patient programmer in different graphical layouts. In some embodiments, the displaying is performed using a clinician programmer or a tablet computer.

The method 500 includes a step 525 of establishing a communications link with the patient programmer.

The method 500 includes a step 530 of receiving signals from the patient programmer via the communications link.

The method 500 includes a step 535 of updating the displaying of the virtual representation of the patient programmer in response to the received signals.

The method 500 includes a step 540 of generating a message in response to a request from the healthcare professional.

The method 500 includes a step 545 of translating the message to the second language.

The method 500 includes a step 550 of sending the translated message to the patient programmer via the communications link.

In some embodiments, the virtual representation of the patient programmer includes a first virtual representation of the patient programmer and a second virtual representation of the patient programmer. The step 505 of associating the first language includes associating the first language with the first virtual representation of the patient programmer. The step 510 of associating the second language includes associating the second language with the second virtual representation of the patient programmer. The step 520 of displaying the virtual representation includes displaying simultaneously the first and second virtual representations of the patient programmer. In various embodiments, the method 500 further includes a step of mirroring the displaying of the first and second virtual representations of the patient programmer as a virtual operation is being performed via one of the first and second virtual representations of the patient programmer. In other embodiments, the first virtual representation of the patient programmer is displayed on a clinician programmer or a tablet computer, and the second virtual representation of the patient programmer is displayed on a monitor remotely located from, but communicatively coupled to, the clinician programmer or the tablet computer.

In some embodiments, the virtual representation is a single virtual representation of the patient programmer. The displaying includes displaying a plurality of menu items on the single virtual representation of the patient programmer in both the first and second languages. In some embodiments, the first language and the second language are displayed in different colors, fonts, or font sizes.

In some embodiments, the first and second languages are associated by detecting the location of the healthcare professional and the location of the patient user, respectively. Based on the detected locations, the languages are suggested as the first and second languages.

In some embodiments, the patient programmer is remotely-located from the healthcare professional such that it is not directly viewable by the healthcare professional.

It is understood that the method 500 may include additional steps that may be performed before, during, or after the steps 505-550, but these additional steps are not illustrated herein for reasons of simplicity.

Based on the above discussions, it can be seen that the patient programmer emulation application of the present disclosure offers advantages. It is understood, however, that not all advantages are necessarily discussed herein, different embodiments may offer different advantages, and that no particular advantage is required for all embodiments. In one aspect, the multi-lingual display of the emulated patient programmer facilitates communication between patients and healthcare professionals who speak different languages. For example, when the healthcare professional is training the patient on how to use the patient programmer, he no longer needs to recall all the menu options or buttons from memory, which would have been the case if the patient programmer was only displayed in the patient's language. Vice versa, the patient would not be confused by the training, since the training is done using an emulated patient programmer that is in both the patient's language and the healthcare professional's language. The patient programmer emulation application's capability to provide instant translations also may obviate the need of a human translator. In addition, the multi-lingual display of the emulated patient programmer also makes remote troubleshooting easier. The patient or the healthcare professional no longer needs to describe the problems or solutions verbally. The healthcare professional and the patient may now “see” what the other party is attempting to show them through the patient programmer emulation application. This reduces the likelihood of miscommunication and increases user satisfaction. Another aspect of the patient programmer emulation application is that it is customized for a specific patient. For example, patient information such as the stimulation parameters for the therapy used to treat that patient are retrieved and reflected in the patient programmer emulation application. By doing so, the healthcare professional can better troubleshoot the patient's problems and provide more accurate recommendations or suggestions.

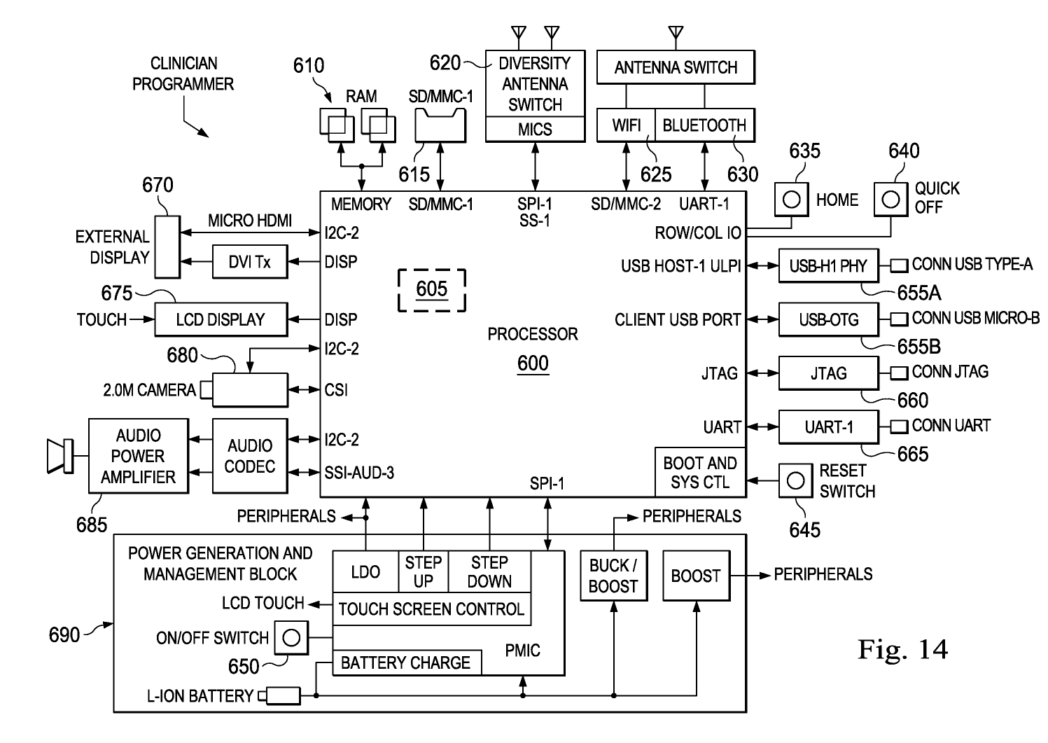

FIG. 14 shows a block diagram of one embodiment of the electronic programmer (CP) discussed herein. For example, the electronic programmer may be a clinician programmer (CP) configured to emulate the patient programmer discussed above. It is understood, however, that alternative embodiments of the electronic programmer may be used to perform these representations as well.

The CP includes a printed circuit board (“PCB”) that is populated with a plurality of electrical and electronic components that provide power, operational control, and protection to the CP. With reference to FIG. 14, the CP includes a processor 600. The processor 600 controls the CP. In one construction, the processor 600 is an applications processor model i.MX515 available from Free scale Semiconductor ®. More specifically, the i.MX515 applications processor has internal instruction and data caches, multimedia capabilities, external memory interfacing, and interfacing flexibility. Further information regarding the i.MX515 applications processor can be found in, for example, the “IMX510EC, Rev. 4” data sheet dated August 2010 and published by Free scale Semiconductor ® at www.freescale.com. The content of the data sheet is incorporated herein by reference. Of course, other processing units, such as other microprocessors, microcontrollers, digital signal processors, etc., can be used in place of the processor 600.

The CP includes memory, which can be internal to the processor 600 (e.g., memory 605), external to the processor 600 (e.g., memory 610), or a combination of both. Exemplary memory include a read-only memory (“ROM”), a random access memory (“RAM”), an electrically erasable programmable read-only memory (“EEPROM”), a flash memory, a hard disk, or another suitable magnetic, optical, physical, or electronic memory device. The processor 600 executes software that is capable of being stored in the RAM (e.g., during execution), the ROM (e.g., on a generally permanent basis), or another non-transitory computer readable medium such as another memory or a disc. The CP also includes input/output (“I/O”) systems that include routines for transferring information between components within the processor 600 and other components of the CP or external to the CP.

Software included in the implementation of the CP is stored in the memory 605 of the processor 600, RAM 610, ROM 615, or external to the CP. The software includes, for example, firmware, one or more applications, program data, one or more program modules, and other executable instructions. The processor 600 is configured to retrieve from memory and execute, among other things, instructions related to the control processes and methods described below for the CP.

One memory shown in FIG. 14 is memory 610, which may be a double data rate (DDR2) synchronous dynamic random access memory (SDRAM) for storing data relating to and captured during the operation of the CP. In addition, a secure digital (SD) multimedia card (MMC) may be coupled to the CP for transferring data from the CP to the memory card via slot 615. Of course, other types of data storage devices may be used in place of the data storage devices shown in FIG. 14.

The CP includes multiple bi-directional radio communication capabilities. Specific wireless portions included with the CP are a Medical Implant Communication Service (MICS) bi-directional radio communication portion 620, a Wi-Fi bi-directional radio communication portion 625, and a Bluetooth bi-directional radio communication portion 630. The MICS portion 620 includes a MICS communication interface, an antenna switch, and a related antenna, all of which allows wireless communication using the MICS specification. The Wi-Fi portion 625 and Bluetooth portion 630 include a Wi-Fi communication interface, a Bluetooth communication interface, an antenna switch, and a related antenna all of which allows wireless communication following the Wi-Fi Alliance standard and Bluetooth Special Interest Group standard. Of course, other wireless local area network (WLAN) standards and wireless personal area networks (WPAN) standards can be used with the CP.

The CP includes three hard buttons: a “home” button 635 for returning the CP to a home screen for the device, a “quick off” button 640 for quickly deactivating stimulation IPG, and a “reset” button 645 for rebooting the CP. The CP also includes an “ON/OFF” switch 650, which is part of the power generation and management block (discussed below).

The CP includes multiple communication portions for wired communication. Exemplary circuitry and ports for receiving a wired connector include a portion and related port for supporting universal serial bus (USB) connectivity 655, including a Type A port and a Micro-B port; a portion and related port for supporting Joint Test Action Group (JTAG) connectivity 660, and a portion and related port for supporting universal asynchronous receiver/transmitter (UART) connectivity 665. Of course, other wired communication standards and connectivity can be used with or in place of the types shown in FIG. 14.

Another device connectable to the CP, and therefore supported by the CP, is an external display. The connection to the external display can be made via a micro High-Definition Multimedia Interface (HDMI) 670, which provides a compact audio/video interface for transmitting uncompressed digital data to the external display. The use of the HDMI connection 670 allows the CP to transmit video (and audio) communication to an external display. This may be beneficial in situations where others (e.g., the surgeon) may want to view the information being viewed by the healthcare professional. The surgeon typically has no visual access to the CP in the operating room unless an external screen is provided. The HDMI connection 670 allows the surgeon to view information from the CP, thereby allowing greater communication between the clinician and the surgeon. For a specific example, the HDMI connection 670 can broadcast a high definition television signal that allows the surgeon to view the same information that is shown on the LCD (discussed below) of the CP.

The CP includes a touch screen I/O device 675 for providing a user interface with the clinician. The touch screen display 675 can be a liquid crystal display (LCD) having a resistive, capacitive, or similar touch-screen technology. It is envisioned that multitouch capabilities can be used with the touch screen display 675 depending on the type of technology used.

The CP includes a camera 680 allowing the device to take pictures or video. The resulting image files can be used to document a procedure or an aspect of the procedure. Other devices can be coupled to the CP to provide further information, such as scanners or RFID detection. Similarly, the CP includes an audio portion 685 having an audio codec circuit, audio power amplifier, and related speaker for providing audio communication to the user, such as the clinician or the surgeon.

The CP further includes a power generation and management block 690. The power block 690 has a power source (e.g., a lithium-ion battery) and a power supply for providing multiple power voltages to the processor, LCD touch screen, and peripherals.

In one embodiment, the CP is a handheld computing tablet with touch screen capabilities. The tablet is a portable personal computer with a touch screen, which is typically the primary input device. However, an external keyboard or mouse can be attached to the CP. The tablet allows for mobile functionality not associated with even typical laptop personal computers. The hardware may include a Graphical Processing Unit (GPU) in order to speed up the user experience. An Ethernet port (not shown in FIG. 14) may also be included for data transfer.

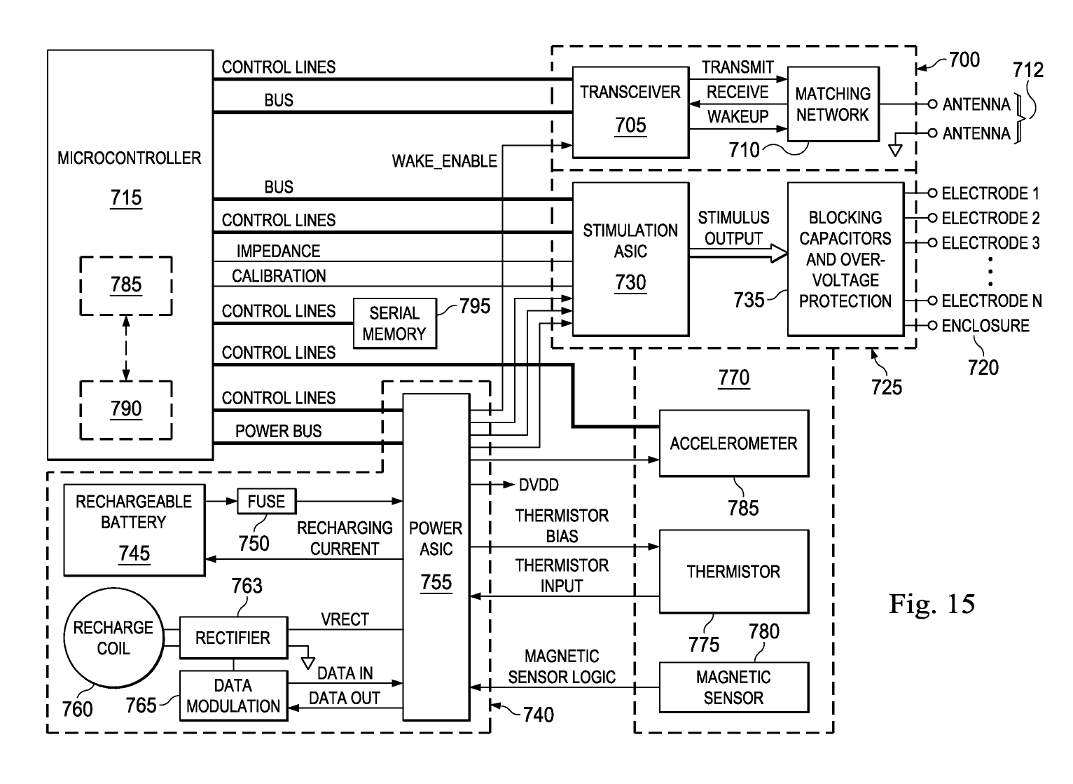

FIG. 15 shows a block diagram of one embodiment of an implantable medical device. In the embodiment shown in FIG. 15, the implantable medical device includes an implantable pulse generator (IPG). The IPG includes a printed circuit board (“PCB”) that is populated with a plurality of electrical and electronic components that provide power, operational control, and protection to the IPG. With reference to FIG. 15, the IPG includes a communication portion 700 having a transceiver 705, a matching network 710, and antenna 712. The communication portion 700 receives power from a power ASIC (discussed below), and communicates information to/from the microcontroller 715 and a device (e.g., the CP) external to the IPG. For example, the IPG can provide bi-direction radio communication capabilities, including Medical Implant Communication Service (MICS) bi-direction radio communication following the MICS specification.

The IPG provides stimuli to electrodes of an implanted medical electrical lead (not illustrated herein). As shown in FIG. 15, N electrodes are connected to the IPG. In addition, the enclosure or housing 720 of the IPG can act as an electrode. The stimuli are provided by a stimulation portion 225 in response to commands from the microcontroller 215. The stimulation portion 725 includes a stimulation application specific integrated circuit (ASIC) 730 and circuitry including blocking capacitors and an over-voltage protection circuit. As is well known, an ASIC is an integrated circuit customized for a particular use, rather than for general purpose use. ASICs often include processors, memory blocks including ROM, RAM, EEPROM, FLASH, etc. The stimulation ASIC 730 can include a processor, memory, and firmware for storing preset pulses and protocols that can be selected via the microcontroller 715. The providing of the pulses to the electrodes is controlled through the use of a waveform generator and amplitude multiplier of the stimulation ASIC 730, and the blocking capacitors and overvoltage protection circuitry 735 of the stimulation portion 725, as is known in the art. The stimulation portion 725 of the IPG receives power from the power ASIC (discussed below). The stimulation ASIC 730 also provides signals to the microcontroller 715. More specifically, the stimulation ASIC 730 can provide impedance values for the channels associated with the electrodes, and also communicate calibration information with the microcontroller 715 during calibration of the IPG.

The IPG also includes a power supply portion 740. The power supply portion includes a rechargeable battery 745, fuse 750, power ASIC 755, recharge coil 760, rectifier 763 and data modulation circuit 765. The rechargeable battery 745 provides a power source for the power supply portion 740. The recharge coil 760 receives a wireless signal from the PPC. The wireless signal includes an energy that is converted and conditioned to a power signal by the rectifier 763. The power signal is provided to the rechargeable battery 745 via the power ASIC 755. The power ASIC 755 manages the power for the IPG. The power ASIC 755 provides one or more voltages to the other electrical and electronic circuits of the IPG. The data modulation circuit 765 controls the charging process.

The IPG also includes a magnetic sensor 780. The magnetic sensor 780 provides a “hard” switch upon sensing a magnet for a defined period. The signal from the magnetic sensor 780 can provide an override for the IPG if a fault is occurring with the IPG and is not responding to other controllers.

The IPG is shown in FIG. 15 as having a microcontroller 715. Generally speaking, the microcontroller 715 is a controller for controlling the IPG. The microcontroller 715 includes a suitable programmable portion 785 (e.g., a microprocessor or a digital signal processor), a memory 790, and a bus or other communication lines. An exemplary microcontroller capable of being used with the IPG is a model MSP430 ultra-low power, mixed signal processor by Texas Instruments. More specifically, the MSP430 mixed signal processor has internal RAM and flash memories, an internal clock, and peripheral interface capabilities. Further information regarding the MSP 430 mixed signal processor can be found in, for example, the “MSP430G2×32, MSP430G2×02 MIXED SIGNAL MICROCONTROLLER” data sheet; dated December 2010, published by Texas Instruments at www.ti.com; the content of the data sheet being incorporated herein by reference.

The IPG includes memory, which can be internal to the control device (such as memory 790), external to the control device (such as serial memory 795), or a combination of both. Exemplary memory include a read-only memory (“ROM”), a random access memory (“RAM”), an electrically erasable programmable read-only memory (“EEPROM”), a flash memory, a hard disk, or another suitable magnetic, optical, physical, or electronic memory device. The programmable portion 785 executes software that is capable of being stored in the RAM (e.g., during execution), the ROM (e.g., on a generally permanent basis), or another non-transitory computer readable medium such as another memory or a disc.

Software included in the implementation of the IPG is stored in the memory 790. The software includes, for example, firmware, one or more applications, program data, one or more program modules, and other executable instructions. The programmable portion 785 is configured to retrieve from memory and execute, among other things, instructions related to the control processes and methods described below for the IPG. For example, the programmable portion 285 is configured to execute instructions retrieved from the memory 790 for sweeping the electrodes in response to a signal from the CP.

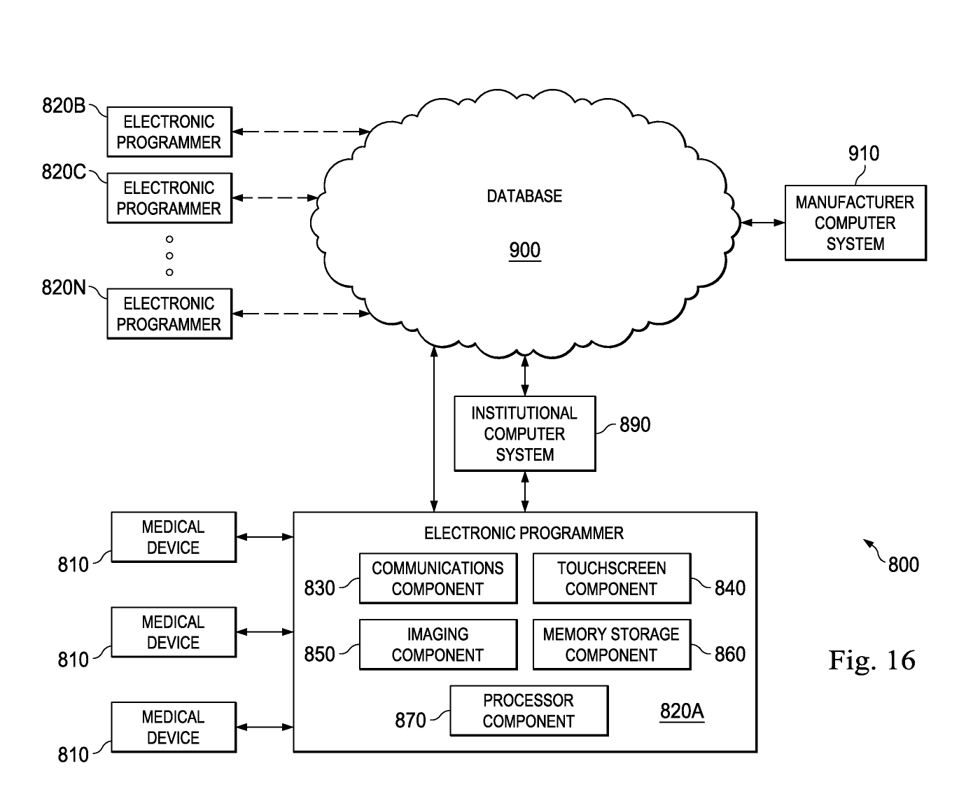

Referring now to FIG. 16, a simplified block diagram of a medical infrastructure 800 (which may also be considered a medical system) is illustrated according to various aspects of the present disclosure. The medical infrastructure 800 includes a plurality of medical devices 810. These medical devices 810 may each be a programmable medical device (or parts thereof) that can deliver a medical therapy to a patient. In some embodiments, the medical devices 810 may include a device of the neurostimulator system discussed above with reference to FIG. 1. For example, the medical devices 810 may be a pulse generator (e.g., the IPG discussed above with reference to FIG. 15), an implantable lead, a charger, or portions thereof. It is understood that each of the medical devices 810 may be a different type of medical device. In other words, the medical devices 810 need not be the same type of medical device.

The medical infrastructure 800 also includes a plurality of electronic programmers 820. For sake of illustration, one of these electronic programmers 820A is illustrated in more detail and discussed in detail below. Nevertheless, it is understood that each of the electronic programmers 820 may be implemented similar to the electronic programmer 820A.

In some embodiments, the electronic programmer 820A may be a clinician programmer, for example the clinician programmer discussed above with reference to FIG. 14. In other embodiments, the electronic programmer 820A may be a patient programmer or another similar programmer. In further embodiments, it is understood that the electronic programmer may be a tablet computer. In any case, the electronic programmer 820A is configured to program the stimulation parameters of the medical devices 810 so that a desired medical therapy can be delivered to a patient.

The electronic programmer 820A contains a communications component 830 that is configured to conduct electronic communications with external devices. For example, the communications device 830 may include a transceiver. The transceiver contains various electronic circuitry components configured to conduct telecommunications with one or more external devices. The electronic circuitry components allow the transceiver to conduct telecommunications in one or more of the wired or wireless telecommunications protocols, including communications protocols such as IEEE 802.11 (Wi-Fi), IEEE 802.15 (Bluetooth), GSM, CDMA, LTE, WIMAX, DLNA, HDMI, Medical Implant Communication Service (MICS), etc. In some embodiments, the transceiver includes antennas, filters, switches, various kinds of amplifiers such as low-noise amplifiers or power amplifiers, digital-to-analog (DAC) converters, analog-to-digital (ADC) converters, mixers, multiplexers and demultiplexers, oscillators, and/or phase-locked loops (PLLs). Some of these electronic circuitry components may be integrated into a single discrete device or an integrated circuit (IC) chip.

The electronic programmer 820A contains a touchscreen component 840. The touchscreen component 840 may display a touch-sensitive graphical user interface that is responsive to gesture-based user interactions. The touch-sensitive graphical user interface may detect a touch or a movement of a user's finger(s) on the touchscreen and interpret these user actions accordingly to perform appropriate tasks. The graphical user interface may also utilize a virtual keyboard to receive user input. In some embodiments, the touch-sensitive screen may be a capacitive touchscreen. In other embodiments, the touch-sensitive screen may be a resistive touchscreen.

It is understood that the electronic programmer 820A may optionally include additional user input/output components that work in conjunction with the touchscreen component 840 to carry out communications with a user. For example, these additional user input/output components may include physical and/or virtual buttons (such as power and volume buttons) on or off the touch-sensitive screen, physical and/or virtual keyboards, mouse, track balls, speakers, microphones, light-sensors, light-emitting diodes (LEDs), communications ports (such as USB or HDMI ports), joy-sticks, etc.

The electronic programmer 820A contains an imaging component 850. The imaging component 850 is configured to capture an image of a target device via a scan. For example, the imaging component 850 may be a camera in some embodiments. The camera may be integrated into the electronic programmer 820A. The camera can be used to take a picture of a medical device, or scan a visual code of the medical device, for example its barcode or Quick Response (QR) code.

The electronic programmer contains a memory storage component 860. The memory storage component 860 may include system memory, (e.g., RAM), static storage 608 (e.g., ROM), or a disk drive (e.g., magnetic or optical), or any other suitable types of computer readable storage media. For example, some common types of computer readable media may include floppy disk, flexible disk, hard disk, magnetic tape, any other magnetic medium, CD-ROM, any other optical medium, RAM, PROM, EPROM, FLASH-EPROM, any other memory chip or cartridge, or any other medium from which a computer is adapted to read. The computer readable medium may include, but is not limited to, non-volatile media and volatile media. The computer readable medium is tangible, concrete, and non-transitory. Logic (for example in the form of computer software code or computer instructions) may be encoded in such computer readable medium. In some embodiments, the memory storage component 860 (or a portion thereof) may be configured as a local database capable of storing electronic records of medical devices and/or their associated patients.

The electronic programmer contains a processor component 870. The processor component 870 may include a central processing unit (CPU), a graphics processing unit (GPU) a micro-controller, a digital signal processor (DSP), or another suitable electronic processor capable of handling and executing instructions. In various embodiments, the processor component 870 may be implemented using various digital circuit blocks (including logic gates such as AND, OR, NAND, NOR, XOR gates, etc.) along with certain software code. In some embodiments, the processor component 870 may execute one or more sequences computer instructions contained in the memory storage component 860 to perform certain tasks.

It is understood that hard-wired circuitry may be used in place of (or in combination with) software instructions to implement various aspects of the present disclosure. Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

It is also understood that the electronic programmer 820A is not necessarily limited to the components 830-870 discussed above, but it may further include additional components that are used to carry out the programming tasks. These additional components are not discussed herein for reasons of simplicity. It is also understood that the medical infrastructure 800 may include a plurality of electronic programmers similar to the electronic programmer 820A discussed herein, but they are not illustrated in FIG. 16 for reasons of simplicity.

The medical infrastructure 800 also includes an institutional computer system 890. The institutional computer system 890 is coupled to the electronic programmer 820A. In some embodiments, the institutional computer system 890 is a computer system of a healthcare institution, for example a hospital. The institutional computer system 890 may include one or more computer servers and/or client terminals that may each include the necessary computer hardware and software for conducting electronic communications and performing programmed tasks. In various embodiments, the institutional computer system 890 may include communications devices (e.g., transceivers), user input/output devices, memory storage devices, and computer processor devices that may share similar properties with the various components 830-870 of the electronic programmer 820A discussed above. For example, the institutional computer system 890 may include computer servers that are capable of electronically communicating with the electronic programmer 820A through the MICS protocol or another suitable networking protocol.

The medical infrastructure 800 includes a database 900. In various embodiments, the database 900 is a remote database—that is, located remotely to the institutional computer system 890 and/or the electronic programmer 820A. The database 900 is electronically or communicatively (for example through the Internet) coupled to the institutional computer system 890 and/or the electronic programmer. In some embodiments, the database 900, the institutional computer system 890, and the electronic programmer 820A are parts of a cloud-based architecture. In that regard, the database 900 may include cloud-based resources such as mass storage computer servers with adequate memory resources to handle requests from a variety of clients. The institutional computer system 890 and the electronic programmer 820A (or their respective users) may both be considered clients of the database 900. In certain embodiments, the functionality between the cloud-based resources and its clients may be divided up in any appropriate manner. For example, the electronic programmer 820A may perform basic input/output interactions with a user, but a majority of the processing and caching may be performed by the cloud-based resources in the database 900. However, other divisions of responsibility are also possible in various embodiments.

According to the various aspects of the present disclosure, electronic data may be uploaded from the electronic programmer 820A to the database 900. The data in the database 900 may thereafter be downloaded by any of the other electronic programmers 820B-820N communicatively coupled to it, assuming the user of these programmers has the right login permissions.

The database 900 may also include a manufacturer's database in some embodiments. It may be configured to manage an electronic medical device inventory, monitor manufacturing of medical devices, control shipping of medical devices, and communicate with existing or potential buyers (such as a healthcare institution). For example, communication with the buyer may include buying and usage history of medical devices and creation of purchase orders. A message can be automatically generated when a client (for example a hospital) is projected to run out of equipment, based on the medical device usage trend analysis done by the database. According to various aspects of the present disclosure, the database 900 is able to provide these functionalities at least in part via communication with the electronic programmer 820A and in response to the data sent by the electronic programmer 820A. These functionalities of the database 900 and its communications with the electronic programmer 820A will be discussed in greater detail later.

The medical infrastructure 800 further includes a manufacturer computer system 910. The manufacturer computer system 910 is also electronically or communicatively (for example through the Internet) coupled to the database 900. Hence, the manufacturer computer system 910 may also be considered a part of the cloud architecture. The computer system 910 is a computer system of medical device manufacturer, for example a manufacturer of the medical devices 810 and/or the electronic programmer 820A.

In various embodiments, the manufacturer computer system 910 may include one or more computer servers and/or client terminals that each includes the necessary computer hardware and software for conducting electronic communications and performing programmed tasks. In various embodiments, the manufacturer computer system 910 may include communications devices (e.g., transceivers), user input/output devices, memory storage devices, and computer processor devices that may share similar properties with the various components 830-870 of the electronic programmer 820A discussed above. Since both the manufacturer computer system 910 and the electronic programmer 820A are coupled to the database 900, the manufacturer computer system 910 and the electronic programmer 820A can conduct electronic communication with each other.

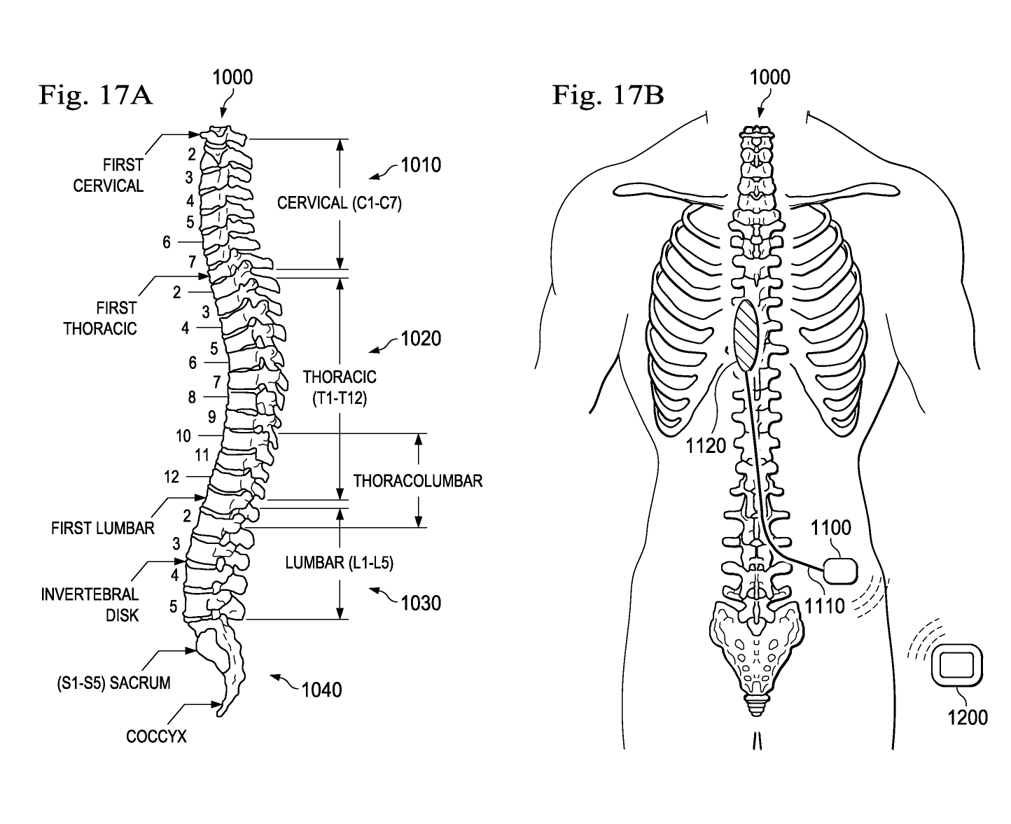

FIG. 17A is a side view of a spine 1000, and FIG. 17B is a posterior view of the spine 1000. The spine 1000 includes a cervical region 1010, a thoracic region 1020, a lumbar region 1030, and a sacrococcygeal region 1040. The cervical region 1010 includes the top 7 vertebrae, which may be designated with C1-C7. The thoracic region 1020 includes the next 12 vertebrae below the cervical region 1010, which may be designated with T1-T12. The lumbar region 1030 includes the final 5 “true” vertebrae, which may be designated with L1-L5. The sacrococcygeal region 1040 includes 9 fused vertebrae that make up the sacrum and the coccyx. The fused vertebrae of the sacrum may be designated with S1-S5.

Neural tissue (not illustrated for the sake of simplicity) branch off from the spinal cord through spaces between the vertebrae. The neural tissue can be individually and selectively stimulated in accordance with various aspects of the present disclosure. For example, referring to FIG. 17B, an IPG device 1100 is implanted inside the body. The IPG device 1100 may include a neurostimulator device. A conductive lead 1110 is electrically coupled to the circuitry inside the IPG device 1100. The conductive lead 1110 may be removably coupled to the IPG device 1100 through a connector, for example. A distal end of the conductive lead 1110 is attached to one or more electrodes 1120. The electrodes 1120 are implanted adjacent to a desired nerve tissue in the thoracic region 1020. Using well-established and known techniques in the art, the distal end of the lead 1110 with its accompanying electrodes may be positioned along or near the epidural space of the spinal cord. It is understood that although only one conductive lead 1110 is shown herein for the sake of simplicity, more than one conductive lead 1110 and corresponding electrodes 1120 may be implanted and connected to the IPG device 1100.

The electrodes 1120 deliver current drawn from the current sources in the IPG device 1100, therefore generating an electric field near the neural tissue. The electric field stimulates the neural tissue to accomplish its intended functions. For example, the neural stimulation may alleviate pain in an embodiment. In other embodiments, a stimulator may be placed in different locations throughout the body and may be programmed to address a variety of problems, including for example but without limitation; prevention or reduction of epileptic seizures, weight control or regulation of heart beats.

It is understood that the IPG device 1100, the lead 1110, and the electrodes 1120 may be implanted completely inside the body, may be positioned completely outside the body or may have only one or more components implanted within the body while other components remain outside the body. When they are implanted inside the body, the implant location may be adjusted (e.g., anywhere along the spine 1000) to deliver the intended therapeutic effects of spinal cord electrical stimulation in a desired region of the spine. Furthermore, it is understood that the IPG device 1100 may be controlled by a patient programmer or a clinician programmer 1200, the implementation of which may be similar to the clinician programmer shown in FIG. 14.

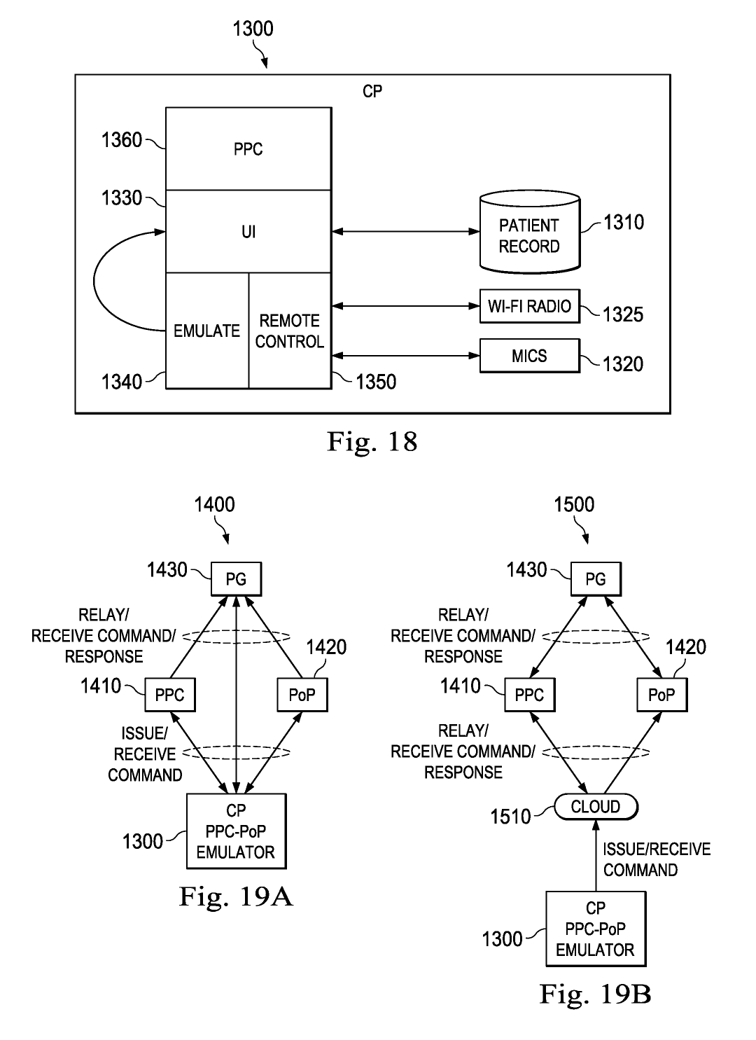

According to various aspects of the present disclosure, the clinician programmer discussed herein may also remotely control a patient programmer, for example via the patient programmer emulator application discussed above. FIG. 18 illustrates a simplified block diagram of an example clinician programmer (CP) 1300 that is configured to remotely control a patient programmer. The CP 1300 may include the circuitry and components of the clinician programmer shown in FIG. 14. The CP 1300 remotely controls the patient programmer so as to program a pulse generator (either internal or external) to deliver stimulation therapy to a patient.

The CP 1300 contains a patient record database 1310, which contains patient information for a plurality of patients. The patient information may include medical history, past programming sessions, current treatment protocol, or biographical and physiological information of the patient. The CP 1300 also contains a MICS radio 1320 for establishing telecommunications with external devices, for example a patient programmer or a network to which the patient programmer may be telecommunicatively coupled. The CP 1300 further contains a Wi-Fi radio 1325 that may be used to establish telecommunications with external devices in addition to (or instead of) the MICS radio 1320.

The CP 1300 has a user interface component 1330, a patient programmer emulation application 1340, a remote control component 1350, and a PPC 1360. The user interface component 1330 may communicate with the patient programmer emulation application 1340. In this manner, the user interface 1330 may be configured to display or emulate various aspects of the patient programmer (which may be a PoP or a PPC) as shown in FIGS. 2-8 and discussed above. The user interface 1330 also communicates with the patient record database 1310 to retrieve necessary or relevant patient information to facilitate the remote controlling of the patient programmer. The remote control component 1350 communicates with the MICS radio 1320 (or the Wi-Fi radio 1325) to establish an actual connection between the CP 1300 and the patient programmer or the network to which the patient programmer is coupled. The PPC 1360 is an example representation of a patient programmer and is used herein to facilitate the emulation and remote control of the patient programmer by the CP 1300.

FIGS. 19A and 19B are simplified block diagrams of medical systems according to various aspects of the present disclosure. In FIG. 19A, an example medical system includes the CP 1300 of FIG. 18 (which includes a PPC or PoP emulator), a PPC (an example patient programmer) 1410 and a PoP (another example patient programmer) 1420, and a pulse generator (PG) 1430. The pulse generator 1430 may be an embodiment of the IPG shown in FIG. 15 as discussed above, or may be an EPG in some other embodiments. The pulse generator 1430 may be programmed by the PPC 1410 or the PoP 1420 to deliver stimulation therapy to a patient. Here, the CP 1300 is capable of not only emulating the functionalities and interfaces of the PPC 1410 and the PoP 1420, but it can also directly control the PPC 1410 and the PoP 1420, for example via a communications link established through the MICS radio 1320 (or the Wi-Fi radio 1325) shown in FIG. 18. As part of the remote controlling, the CP 1300 issues commands to, and receives commands from, the PPC 1410 and PoP 1420, and vice versa. These commands may include, as examples, programming instructions for programming the pulse generator 1430. The commands from the CP 1300 are relayed to the pulse generator 1430 by the PPC 1410 or the PoP 1420. From the perspective of the pulse generator 1430, it is as if these commands are received directly from the PPC 1410 or the PoP 1420. The pulse generator 1430 then delivers suitable stimulation therapy to a patient based on these commands.

FIG. 19B illustrates an example medical system 1500 that is similar to the system 1400 shown in FIG. 19A, and therefore similar components are labeled the same in both FIGS. 19A-19B for reasons of consistency and clarity. Unlike the system 1400, however, the system 1500 employs a cloud 1510 (i.e., an example network) to facilitate the communication between the CP 1300 and the PPC 1410 and PoP 1420. In other words, the CP 1300 does not establish communication directly with the PPC 1410 and the PoP 1420. Rather, the CP 1300, the PPC 1410, and the PoP 1420 are each communicatively coupled to the cloud 1510. The commands exchanged between the CP 1300, the PPC 1410, and the PoP 1420 are relayed through the cloud 1510 before reaching the intended target entity. In any case, the pulse generator 1430 is still programmed (by the PPC 1410 or PoP 1420 that is under the control of the CP 1300) to deliver a suitable stimulation therapy to the patient.

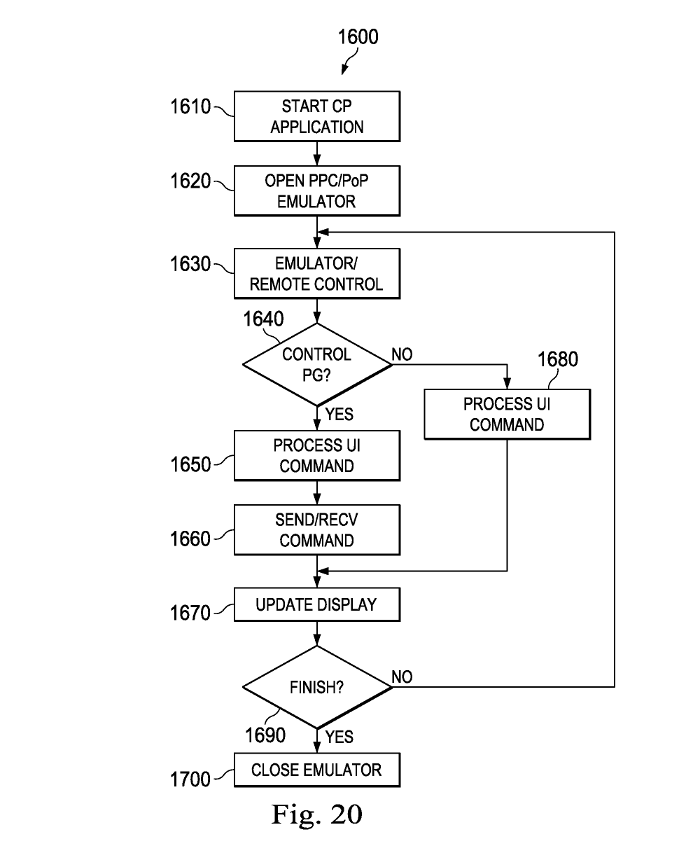

FIG. 20 is a simplified flowchart of a method 1600 for using a clinician programmer to remotely control a patient programmer. The method 1600 includes a step 1610 in which the clinician programmer application is started. The method 1600 includes a step 1620 in which the patient programmer application (may be a PPC emulator or a PoP emulator) is opened. The method 1600 includes a step 1630 in which the emulator application initiates remote control of the PPC or the PoP. The method 1600 includes a decision step 1640 to determine whether or not the control the pulse generator (that is programmed by the PPC or the PoP). If the answer from the decision step 1640 is yes, the method 1600 then proceeds to a step 1650 to process the UI (user interface) commands. These UI commands are then sent to and received by the PPC or the PoP in step 1660. These UI commands include programming instructions for programming the pulse generator. The display on the clinician programmer is then updated in step 1670.

However, if the answer from the decision step 1640 is no, then the clinician programmer remains in the emulator mode and merely emulates the PPC or PoP without exerting control over the PPC or the PoP. In the emulator mode, the clinician programmer does not communicate with the pulse generator. The UI commands are processed in step 1680 in the emulator mode, and once again the display on the clinician programmer is updated in step 1670. The method 1600 then continues with another decision step 1690 to determine whether the session is finished. If the answer is no, then the method 1600 loops back to the step 1630. If the answer from the decision step 1690 is yes, then the method 1600 finishes at 1700, in which the emulator application on the clinician programmer is closed. It is understood that additional steps may be performed before, during, or after the steps 1610-1700 discussed herein, and that the steps 1610-1700 may only be briefly discussed herein, and that the steps 1610-1700 need not necessarily be performed in a numerical order or in the order shown in FIG. 20 unless otherwise specified.

The foregoing has outlined features of several embodiments so that those skilled in the art may better understand the detailed description that follows. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

What is claimed is:

1. An electronic device for emulating a patient programmer, the electronic device comprising:
a touchscreen display configured to receive a tactile input from a user and display a visual output;
a memory storage component configured to store programming code; and
a computer processor configured to execute the programming code to perform the following tasks:
associating a first language with a virtual representation of the patient programmer, the first language corresponding to a language understood by a healthcare professional;
associating a second language with the virtual representation of the patient programmer, the second language corresponding to a language understood by a patient user of the patient programmer; and
displaying the virtual representation of the patient programmer in the first language and in the second language simultaneously.

2. The electronic device of claim 1, wherein:
the virtual representation comprises a first virtual representation of the patient programmer and a second virtual representation of the patient programmer;
the associating the first language comprises associating the first language with the first virtual representation of the patient programmer;
the associating the second language comprises associating the second language with the second virtual representation of the patient programmer; and
the displaying comprises displaying simultaneously the first and second virtual representations of the patient programmer.

3. The electronic device of claim 2, wherein the tasks further comprise: mirroring the displaying of the first and second virtual representations of the patient programmer as a virtual operation is being performed via one of the first and second virtual representations of the patient programmer.

4. The electronic device of claim 2, wherein the displaying comprises displaying the first and second virtual representations of the patient programmer in different graphical layouts.

5. The electronic device of claim 1, wherein the virtual representation is a single virtual representation of the patient programmer, and wherein the displaying comprises displaying a plurality of menu items on the single virtual representation of the patient programmer in both the first and second languages.

6. The electronic device of claim 5, wherein the first language and the second language are displayed in different colors, fonts, or font sizes.

7. The electronic device of claim 1, wherein the tasks further comprise: retrieving patient information associated with the patient user, wherein the displaying comprises displaying at least a subset of the retrieved patient information in the virtual representation of the patient programmer.

8. The electronic device of claim 7, wherein the patient information includes information regarding an electrical stimulation therapy delivered to the patient user by a medical device implanted in the patient user.

9. The electronic device of claim 8, wherein:
the medical device includes an implantable pulse generator (IPG); and
the information with respect to the electrical stimulation therapy includes one or more electrical stimulation parameters selected from the group consisting of: current amplitude, frequency, pulse width, and electrode configuration on the IPG.

10. The electronic device of claim 1, wherein the associating the second language comprises:
detecting a location of the patient programmer; and
suggesting, based on the detected location, one or more languages as the second language.

11. The electronic device of claim 1, wherein the displaying comprises:
displaying the first virtual representation of the patient programmer on a clinician programmer or a tablet computer; and
displaying the second virtual representation of the patient programmer on a monitor remotely located from, but communicatively coupled to, the clinician programmer or the tablet computer.

12. The electronic device of claim 1, wherein the tasks further comprise:
establishing a communications link with the patient programmer;
receiving signals from the patient programmer via the communications link; and
updating the displaying of the virtual representation of the patient programmer in response to the received signals.

13. The electronic device of claim 12, wherein the tasks further comprise:
generating a message in response to a request from the healthcare professional;
translating the message to the second language; and
sending the translated message to the patient programmer via the communications link.

14. The electronic device of claim 1, wherein the patient programmer is remotely-located from the healthcare professional such that it is not directly viewable by the healthcare professional.

15. A medical system, comprising:
a patient programmer configured to adjust a stimulation therapy that is delivered to a patient through an implanted pulse generator; and
an electronic device configured to provide an emulation of the patient programmer, wherein the electronic device includes a non-transitory, tangible machine-readable storage medium storing executable instructions that when executed electronically by one or more processors, perform the following steps:
associating a first language with a virtual representation of the patient programmer, the first language corresponding to a language understood by a healthcare professional;
associating a second language with the virtual representation of the patient programmer, the second language corresponding to a language understood by a patient user of the patient programmer; and
displaying the virtual representation of the patient programmer in the first language and in the second language simultaneously.

16. The medical system of claim 15, wherein:
the virtual representation comprises a first virtual representation of the patient programmer and a second virtual representation of the patient programmer;
the associating the first language comprises associating the first language with the first virtual representation of the patient programmer;
the associating the second language comprises associating the second language with the second virtual representation of the patient programmer; and
the displaying comprises displaying simultaneously the first and second virtual representations of the patient programmer.

17. The medical system of claim 16, wherein the steps further comprise: mirroring the displaying of the first and second virtual representations of the patient programmer as a virtual operation is being performed via one of the first and second virtual representations of the patient programmer.

18. The medical system of claim 16, wherein the displaying comprises displaying the first and second virtual representations of the patient programmer in different graphical layouts.

19. The medical system of claim 15, wherein the virtual representation is a single virtual representation of the patient programmer, and wherein the displaying comprises displaying a plurality of menu items on the single virtual representation of the patient programmer in both the first and second languages.

20. The medical system of claim 19, wherein the first language and the second language are displayed in different colors, fonts, or font sizes.

21. The medical system of claim 15, wherein the steps further comprise: retrieving patient information associated with the patient user, wherein the displaying comprises displaying at least a subset of the retrieved patient information in the virtual representation of the patient programmer.

22. The medical system of claim 21, wherein the patient information includes information regarding an electrical stimulation therapy delivered to the patient user by a medical device implanted in the patient user.

23. The medical system of claim 22, wherein:
the medical device includes an implantable pulse generator (IPG); and
the information with respect to the electrical stimulation therapy includes one or more electrical stimulation parameters selected from the group consisting of: current amplitude, frequency, pulse width, and electrode configuration on the IPG.

24. The medical system of claim 15, wherein the associating the second language comprises:
detecting a location of the patient programmer; and
suggesting, based on the detected location, one or more languages as the second language.

25. The medical system of claim 15, wherein the displaying comprises:
displaying the first virtual representation of the patient programmer on a clinician programmer or a tablet computer; and
displaying the second virtual representation of the patient programmer on a monitor remotely located from, but communicatively coupled to, the clinician programmer or the tablet computer.

26. The medical system of claim 15, wherein the steps further comprise:
establishing a communications link with the patient programmer;
receiving signals from the patient programmer via the communications link; and
updating the displaying of the virtual representation of the patient programmer in response to the received signals.

27. The medical system of claim 26, wherein the steps further comprise:
generating a message in response to a request from the healthcare professional;
translating the message to the second language; and
sending the translated message to the patient programmer via the communications link.

28. The medical system of claim 15, wherein the patient programmer is remotely-located from the healthcare professional such that it is not directly viewable by the healthcare professional.

29. A method of emulating a patient programmer, comprising:
associating a first language with a virtual representation of the patient programmer, the first language corresponding to a language understood by a healthcare professional;
associating a second language with the virtual representation of the patient programmer, the second language corresponding to a language understood by a patient user of the patient programmer; and
displaying the virtual representation of the patient programmer in the first language and in the second language simultaneously.

30. The method of claim 29, wherein:
the virtual representation comprises a first virtual representation of the patient programmer and a second virtual representation of the patient programmer;
the associating the first language comprises associating the first language with the first virtual representation of the patient programmer;
the associating the second language comprises associating the second language with the second virtual representation of the patient programmer; and
the displaying comprises displaying simultaneously the first and second virtual representations of the patient programmer.

31. The method of claim 30, further comprising: mirroring the displaying of the first and second virtual representations of the patient programmer as a virtual operation is being performed via one of the first and second virtual representations of the patient programmer.

32. The method of claim 30, wherein the displaying comprises displaying the first and second virtual representations of the patient programmer in different graphical layouts.

33. The method of claim 29, wherein the virtual representation is a single virtual representation of the patient programmer, and wherein the displaying comprises displaying a plurality of menu items on the single virtual representation of the patient programmer in both the first and second languages.

34. The method of claim 33, wherein the first language and the second language are displayed in different colors, fonts, or font sizes.

35. The method of claim 29, further comprising: retrieving patient information associated with the patient user, wherein the displaying comprises displaying at least a subset of the retrieved patient information in the virtual representation of the patient programmer.

36. The method of claim 35, wherein the patient information includes information regarding an electrical stimulation therapy delivered to the patient user by a medical device implanted in the patient user.

37. The method of claim 36, wherein:
the medical device includes an implantable pulse generator (IPG); and
the information with respect to the electrical stimulation therapy includes one or more electrical stimulation parameters selected from the group consisting of: current amplitude, frequency, pulse width, and electrode configuration on the IPG.

38. The method of claim 29, wherein the associating the second language comprises:
detecting a location of the patient programmer; and
suggesting, based on the detected location, one or more languages as the second language.

39. The method of claim 29, wherein the displaying comprises:
displaying the first virtual representation of the patient programmer on a clinician programmer or a tablet computer; and
displaying the second virtual representation of the patient programmer on a monitor remotely located from, but communicatively coupled to, the clinician programmer or the tablet computer.

40. The method of claim 29, further comprising:
establishing a communications link with the patient programmer;
receiving signals from the patient programmer via the communications link; and
updating the displaying of the virtual representation of the patient programmer in response to the received signals.

41. The method of claim 40, further comprising:
generating a message in response to a request from the healthcare professional;
translating the message to the second language; and
sending the translated message to the patient programmer via the communications link.

42. The method of claim 29, wherein the patient programmer is remotely-located from the healthcare professional such that it is not directly viewable by the healthcare professional.
